(19) United States
(12) Patent Application Publication
(10) Pub. No.: US 2026/0086787 A1
(43) Pub. Date: Mar. 26, 2026

(54) SYSTEMS AND METHODS FOR UTILIZING ONBOARD VEHICLE HARDWARE FOR SECURE ECU DATA COMMUNICATION

(71) Applicant: Adeia Guides Inc., San Jose, CA (US)

(72) Inventor: Charles Dasher, Lawrenceville, GA (US)

(21) Appl. No.: 18/898,398

(22) Filed: Sep. 26, 2024

(51) Int. Cl. G06F 8/61; H04L 9/32

(52) U.S. Cl. CPC G06F 8/63; H04L 9/3247

(57) ABSTRACT

Aspects of the present application utilizes onboard vehicle hardware for secure ECU data communication. In some embodiments, a main ECU receives a private key from a certificate authority and stores it within a hardware security module (HSM). The main ECU may then generate a symmetric vehicle-specific key based on at least one vehicle parameter of the vehicle (e.g., the odometer) and store it in the HSM. An additional ECU may be detected by the main ECU on a vehicle communication network (e.g., ethernet). The additional ECU may be an FPGA that includes an unprovisioned vehicle control operation. The main ECU may generate an FPGA image for the additional ECU where the FPGA image has the symmetric vehicle-specific key. The main ECU may then cryptographically sign the FPGA image using the private key stored in the HSM and transmit the signed FPGA image to the additional ECU for installation.

### BACKGROUND

This disclosure is related to vehicle hardware communication, and in particular, to utilizing an electronic control unit (ECU) for secure data communication within a vehicle-based network.

### SUMMARY

In one approach to automotive systems, vehicle hardware control is performed by one or more fixed-function ECUs dedicated to specific functions such as engine management, braking, air conditioning, etc. These fixed-function ECUs are interconnected through extensive wiring harnesses, adding to the vehicle's physical bulk and weight. The complexity of this setup not only complicates manufacturing processes by raising costs due to the diverse range of parts required, but also makes diagnostics, repairs, and updates challenging. Each fixed-function ECU requires specific programming and maintenance, and issues across these units demand a high level of technical skill to diagnose. Furthermore, upgrading or modifying system functionalities often involves physical replacements or significant rewiring, limiting the system's adaptability to incorporate new technologies or improve performance features.

Integrating Field-Programmable Gate Arrays (FPGAs) into vehicle systems provides an alternative to fixed-function ECUs to make vehicle operations more versatile by using reconfigurable hardware platforms. FPGA based ECUs enhance the adaptability of vehicle electronics, allowing for on-the-fly reprogramming to meet various operational demands. This reduces the number of hardware components needed by consolidating multiple functions into fewer, versatile units, thereby simplifying the system architecture, decreasing weight, and reducing costs. Furthermore, FPGA based ECUs facilitate the rapid deployment of new features and system updates through software changes rather than hardware modifications, significantly boosting the vehicle's capacity to swiftly integrate and adapt to new technologies and functionalities. In addition to transitioning to FPGA based ECUs, the common approach of using a controller area network (CAN) bus as the vehicle communication network can be replaced with an ethernet bus. CAN is deficient in cybersecurity protocols and bandwidth required for large amounts of data throughput in vehicles having advanced technology systems. Moreover, ethernet bus vehicle communication network implementations, while providing increased bandwidth, remain deficient in cybersecurity protocols which an increased risk of theft, nefarious hacking, and erroneous operations. Thus, these approaches do not provide for a vehicle specific cybersecurity solution for an ethernet bus enabled vehicle communication network.

In particular, if an FGPA based ECU is unsecured, any party may configure the ECU.

This may lead to a multitude of problems. For example, a mechanic may negligently install incorrect configuration for the deficiently secure ECU as the communication network over network omits any authentication and verification of party, installation, and data to be installed on the ECU. Having the ECU installed with incorrect data may lead to poor performance and even safety hazards. Another example may be a nefarious actor who wishes to hack the vehicle through the ethernet bus by installing rogue data on the ECU and/or spyware. Having an unsecure ethernet bus as the communication channel leaves the communication channel susceptible to the various threats listed above.

To help address these problems, systems and methods are provided herein for utilizing onboard vehicle hardware for secure ECU data communication. In some embodiments, a main ECU receives (e.g., during the manufacturing process) a private key from a certificate authority (e.g., from a system run at the factory by manufacturers) and stores it within a hardware security module (HSM). The manufacturer may then delete any local copy of the private key, such that the private key is only stored by the main ECU. For example, the vehicle's main ECU receives a private key from the vehicle manufacturer and stores it within the HSM. The main ECU may then generate a symmetric vehicle-specific key based on at least one vehicle parameter of the vehicle (e.g., the odometer of the vehicle, VIN number of the vehicle, vehicle serial number, etc.) and store it in the HSM. An additional ECU may be detected by the main ECU on a vehicle communication network (e.g., ethernet). The additional ECU may be an FPGA unconfigured for a vehicle control operation. The main ECU may generate an FPGA image for the additional ECU where the FPGA image has the symmetric vehicle-specific key. The main ECU may then cryptographically sign the FPGA image using the private key stored in the HSM and transmit the signed FPGA image to the additional ECU for installation. The additional ECU verifies the signed FPGA image using the public key provided by the certificate authority (e.g., the vehicle manufacturer or a certificate authority that received the public key from the vehicle manufacturer). Moreover, the additional ECU may communicate with the main ECU over the vehicle communication network by encrypting messages using the symmetric vehicle-specific key.

By providing the additional ECU with the symmetric key (based on a specific vehicle parameter like mileage on the odometer) for communication over the ethernet vehicle communication network, a level of heightened cybersecurity is implemented to ensure that communications between the main ECU and the additional ECU are both fast and secure. Performing all the encryption and decryption of the vehicle-specific symmetric key ensures a high efficiency that need not communicate with external parties to verify security. Having this implementation, in particular the vehicle-specific symmetric key based on the specific vehicle parameter, significantly mitigates any erroneous or negligent installation of incorrect configuration for the ECU and/or any nefarious installation of rogue configuration/spyware to be installed within the ECU. Thus, the vehicle control systems are secured in two complimenting ways. An additional ECU cannot be provisioned with any configuration other than configuration data provided by the main ECU since, since only the main ECU can sign the FPGA image or configuration data with its private key. Moreover, even if an unauthorized version of an FPGA was somehow installed by mistake or by a nefarious party to the additional ECU, the additional ECU would not be able to communicate on the vehicle network since it would lack the necessary symmetric key that is required for such communication, because such keys are only distributed as part of the authorized FPGA image distribution by the main ECU.

In some embodiments, the addition ECU may be preprovisioned with a provisional FPGA image. The provisional FGPA image enables the additional ECU to perform networking and cryptographic operations, and does not enable the additional ECU to perform the vehicle control operations. The additional ECU may receive the public key from the certificate authority (e.g., the vehicle manufacturer) using the provisional FPGA image and verify the signed FPGA image by decrypting a signature of the FPGA image that was signed using the private key. In other embodiments, the main ECU may transmit the provisional FPGA image to the additional ECU (enabling the additional ECU to perform networking and cryptographic operations, but not enabling the additional ECU to perform vehicle control operations.) In some embodiments, the main ECU may apply a hash function to the vehicle parameter when generating the vehicle-specific symmetric key. For example, the main ECU may use a hashing algorithm such as SHA-256 to hash the odometer reading that may be padded to enhance the hash function. The hash may then be used as a seed to any suitable key generating algorithm. For example, the main ECU may use Advanced Encryption Standard (AES) algorithm with cryptographically secure pseudorandom number generator (CSPRNG) that is seeded with the hash to create a key. Any other suitable key generation standard may be used (e.g., Blowfish, ChaCha20, etc.) or any combination of the above.

In some embodiments, the main ECU communicates to the additional ECU via the vehicle communication network that includes an ethernet bus. The communication over the ethernet bus between the main ECU and additional ECU includes exchange of encrypted ethernet frames where the encryption is implemented via the symmetric vehicle-specific key.

In some embodiments, the main ECU determines an expiration date of the signed FPGA image by determining whether the current date is within a threshold of the expiration date (e.g., within one month). If so, the main ECU generates a new FPGA image for the additional ECU that includes the symmetric vehicle-specific key and cryptographically encrypts the new FPGA image using this key. The main ECU then transmits the new encrypted FPGA image to the additional ECU for installation. At this point the additional ECU can decrypt the encrypted FPGA image to install the image that enables the additional ECU to now perform vehicle control operations. In the example above, the previous symmetric vehicle-specific key would be revoked, and the new symmetric vehicle-specific key sent with the encrypted image would remain active until the expiration date for this current key.

In some embodiments, the main ECU may configure virtual local area networks (VLANs) such that a first VLAN may encrypt communications via the symmetric vehicle-specific key, and a second VLAN may encrypt communications via an additional symmetric vehicle-specific key. The additional symmetric vehicle-specific key is generated using a different vehicle parameter than the symmetric vehicle-specific key. For example, if the symmetric vehicle-specific key used the odometer to generate its key, the additional symmetric vehicle-specific key may use the engine code as the vehicle parameter to generate its key. VLANs may provide dedicated subnetworks for enhanced efficiency and allocated bandwidth for specific vehicle operations.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1A shows an illustrative scenario where a main ECU generates a vehicle-specific symmetric key, in accordance with some embodiments of this disclosure.

FIG. 1B shows an illustrative scenario where the main ECU detects an additional ECU and generates an encrypted FPGA image, whether a computing set is available to perform the compute task, in accordance with some embodiments of this disclosure.

FIG. 1C shows an illustrative scenario where the additional ECU verifies the signature of the FPGA image and installs the FPGA image, in accordance with some embodiments of this disclosure.

FIG. 1D shows an illustrative scenario where the main ECU and additional ECU transfer data over the ethernet bus using the vehicle-specific symmetric key, in accordance with some embodiments of this disclosure.

FIG. 2 shows an illustrative scenario of a hashing function to create the vehicle-specific symmetric key, in accordance with some embodiments of this disclosure.

FIG. 3 shows an illustrative scenario of a vehicle including multiple ECUs controlling vehicle operations, in accordance with some embodiments of this disclosure.

FIG. 4 shows an illustrative scenario of multiple virtual local area networks implemented on the vehicle communication network, in accordance with some embodiments of this disclosure.

FIG. 5 shows an illustrative scenario of a system diagram of a main ECU, additional ECUs, and a Certificate Authority that is a vehicle manufacturer, in accordance with some embodiments of this disclosure.

FIG. 6A shows an illustrative scenario of a flow diagram of confirming secure configuration of an additional ECU, in accordance with some embodiments of this disclosure.

FIG. 6B shows a continued illustrative scenario of a flow diagram of confirming secure configuration of an additional ECU, in accordance with some embodiments of this disclosure.

FIG. 7 shows an illustrative scenario of a flow diagram of confirming secure configuration of an additional ECU, in accordance with some embodiments of this disclosure.

FIG. 8 shows an illustrative scenario of a flow diagram of allowing communication if credentials are valid of an additional ECU, in accordance with some embodiments of this disclosure.

FIG. 9 shows an illustrative scenario of a flow diagram of main ECU load balancing tasks to an additional ECU, in accordance with some embodiments of this disclosure.

FIG. 10 shows an illustrative scenario of a flow diagram of main ECU implementing a predictive additional ECU, in accordance with some embodiments of this disclosure.

FIG. 11 shows an illustrative scenario of a flow diagram of a main ECU implementing a backup additional ECU, in accordance with some embodiments of this disclosure.

FIG. 12 shows an illustrative scenario of a flow diagram of a main ECU monitoring the operational state of an additional ECU, in accordance with some embodiments of this disclosure.

FIG. 13 shows an illustrative scenario of a flow diagram of a main ECU monitoring the resource availability of an additional ECU, in accordance with some embodiments of this disclosure.

FIG. 14 shows an illustrative scenario of a flow diagram of a main ECU implementing VLAN configurations, in accordance with some embodiments of this disclosure.

FIG. 15 is a block diagram of an exemplary vehicle system configured to interface with a system for secure ECU data communication, in accordance with some disclosed embodiments of the disclosure.

FIG. 16 is a block diagram of an exemplary system for secure ECU data communication, in accordance with some embodiments of the disclosure.

FIG. 17 is a flowchart of a detailed illustrative process for transmitting a signed FPGA image to an additional ECU for installation, in accordance with some embodiments of this disclosure.

FIG. 18 is a flowchart of a detailed illustrative process for generating a new FPGA image for an additional ECU in response to the expiration date determined to be within an expiration threshold, in accordance with some embodiments of this disclosure.

### DETAILED DESCRIPTION

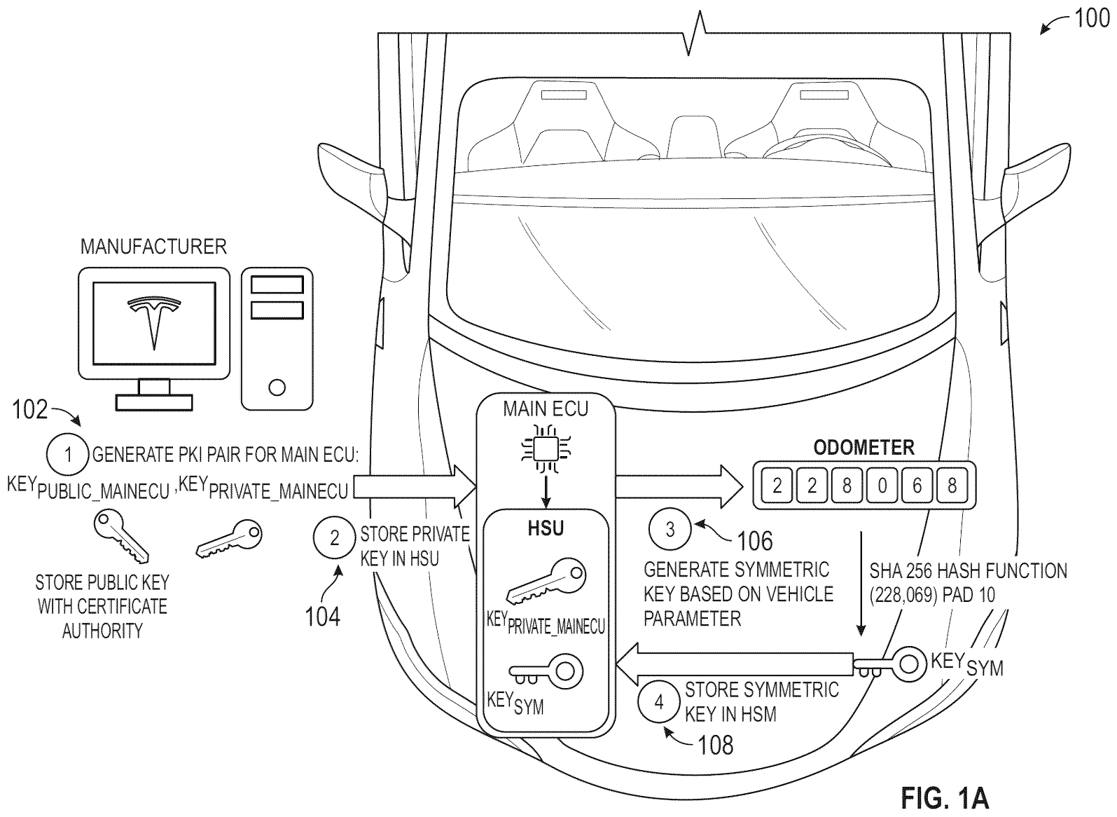

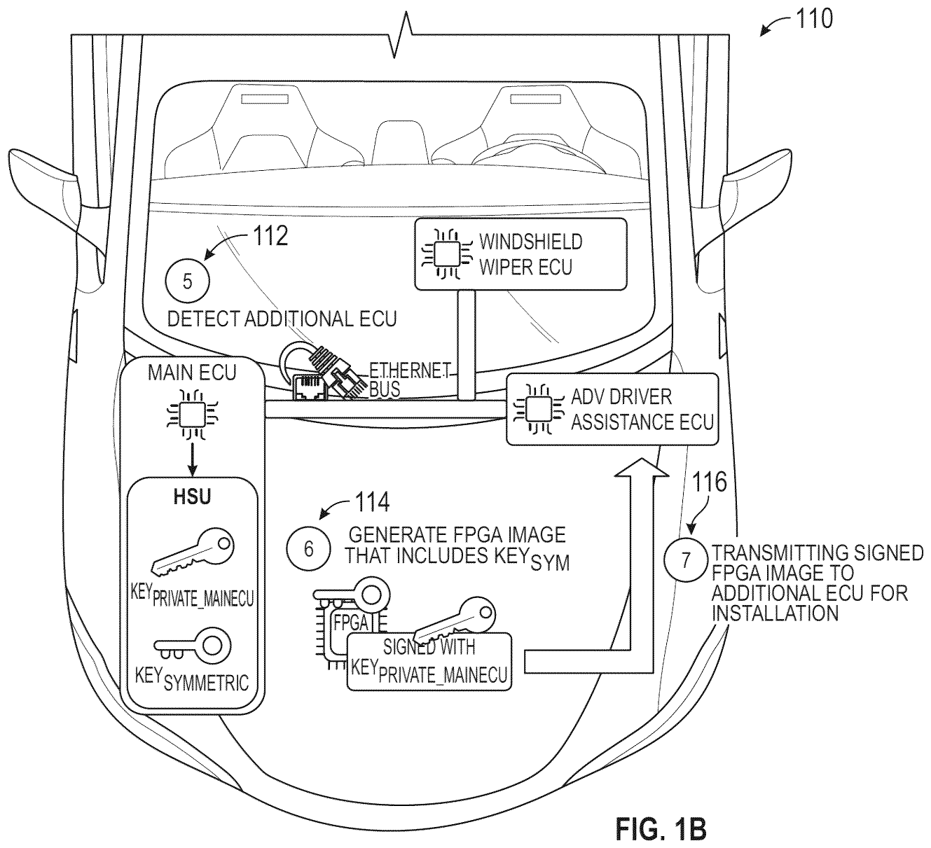

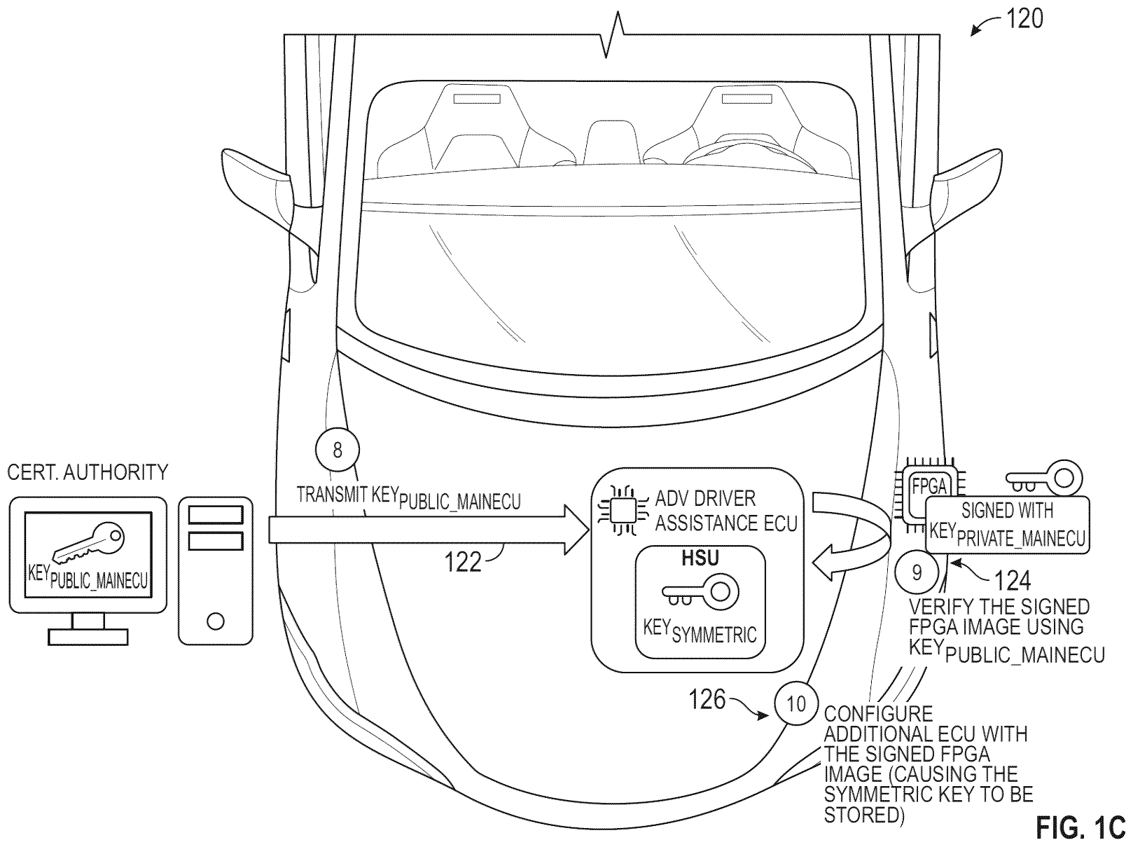

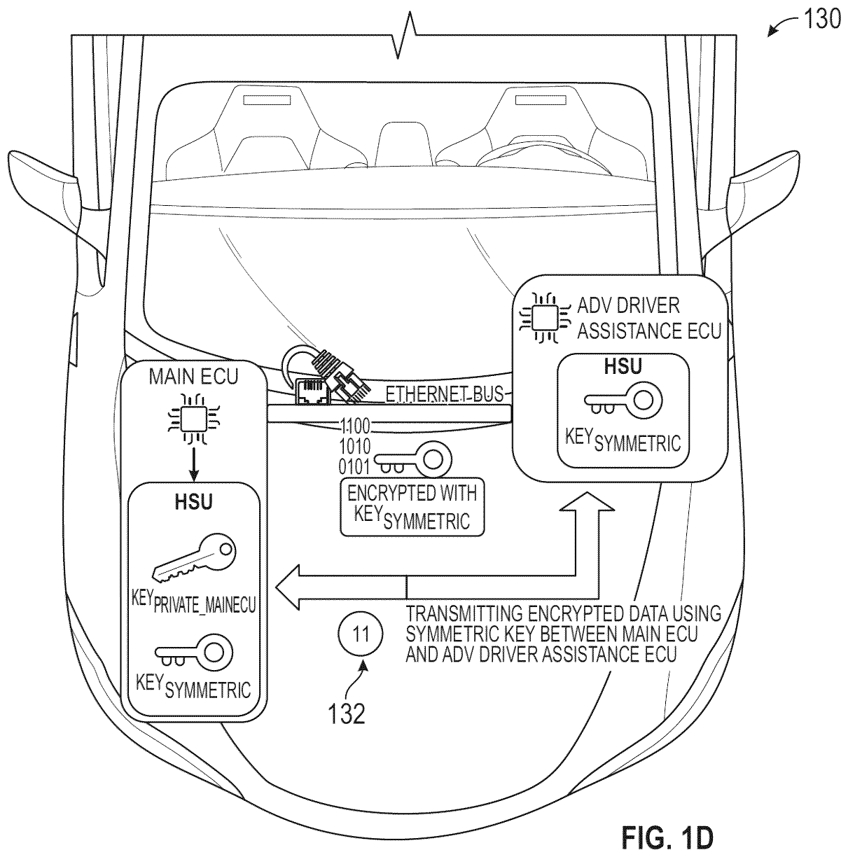

FIG. 1A shows an illustrative scenario 100 where a main ECU generates a vehicle-specific symmetric key, in accordance with some embodiments of this disclosure. In some embodiments, the main ECU, in addition to controlling electrical and other subsystems of the vehicle, may receive a private key from a certificate authority. If there are a plurality of ECUs, a particular ECU of the plurality of ECUs may be designated as a main ECU. This designation may be predefined or selected via a selection process by the plurality of ECUs. In other embodiments, the certificate authority may designate the ECU as the main ECU where the main ECU solely performs security functions for the vehicle (including all subsystems). The certificate authority may be an entity that provides private keys. In some embodiments, the certificate authority may be one or more servers provided and/or operated by manufacturer. In some embodiments, the certificate authority may be one or more servers provided and/or operated by a trusted 3rd party, e.g., DigiCert™, Comodo™ or any other suitable certificate authority services provider. In some embodiments, the certificate authority may be one or more servers provided and/or operated by manufacturer. In some embodiments, the certificate authority may be one or more servers provided and/or operated by a trusted 3rd party, e.g., DigiCert™, Comodo™ or any other suitable certificate authority services provider. For example, a vehicle having a main ECU may receive the private key from a manufacturer device that is hardwired to the vehicle. In another example, the certificate authority may be a trusted third-party security company. A private key may be any cryptographic key that can be obtained and used by the main ECU to encrypt messages intended for additional ECUs, such that the encrypted messages can be deciphered only by using a paired public key. In FIG. 1A, at 102, the vehicle manufacturer uses a public key infrastructure that generates both a main ECU public key and a main ECU private key. The public key may be stored at the certificate authority (e.g., the vehicle manufacturer). In other embodiments, the public key may be stored at a separate certificate authority for storage, where the separate certificate authority is different than the certificate authority that provides the key(s).

In some embodiments, the main ECU may store the private key in a hardware security module (HSM) of the main ECU. The hardware security module may be physical module within the memory (or standalone) within the main ECU that may be tamper and intrusion-resistant.

This mitigates risk of any unauthorized access to this specific module. The HSM may safeguard and manage digital keys for cryptographic functions. The HSM may be certified according to internationally recognized standards such as Common Criteria (e.g. using Protection Profile EN 419 221-5, “Cryptographic Module for Trust Services”) or FIPS 140 (currently the 3rd version, often referred to as FIPS 140-3). Returning to FIG. 1A at 104, the main ECU stores the main ECU private key in the HSU.

In some embodiments, the main ECU may generate a symmetric vehicle-specific key based on at least one vehicle parameter of the vehicle. A vehicle parameter may include, but is not limited to, the vehicle identification number (VIN) of the vehicle, the odometer reading of the vehicle, the serial number of the vehicle, the engine model number of the vehicle, or a part number of the vehicle. In some embodiments, any metric or identifier that is related to the vehicle may serve as the vehicle parameter. The symmetric vehicle-specific key may be any cryptographic key that may be used by the main ECU or any additional ECU (e.g., to perform any non-security vehicle subsystem functions) to encrypt and decrypt communications on the vehicle communication network. Returning to FIG. 1A at 106, the main ECU generates the symmetric vehicle-specific key based on the odometer that has a reading of 228,069 miles. In some embodiments, the main ECU applies a hash function to the at least one vehicle parameter of the vehicle to generate a hashed vehicle parameter. The hashed vehicle parameter may be used a seed for a pseudorandom key generation algorithm to generate the vehicle-specific symmetric key. Continuing with the example, the odometer reading of 228,069 may be padded to include adding data to the beginning, middle, or end of the odometer reading prior to the hash function. Subsequent to the padding, the padded odometer reading may be hashed using a hash function (e.g., SHA-256). Any other suitable hash function may be implemented. The main ECU may then generate the symmetric vehicle-specific key based on at least the hashed vehicle parameter. The main ECU may then store the symmetric vehicle-specific key in the HSM of the main ECU. Returning to FIG. 1A at 108, the generated symmetric vehicle-specific key is stored in the main ECU's HSM. The symmetric vehicle-specific key may be used by the main ECU to communicate with one or more additional ECUs over the vehicle communication network where all data is encrypted and decrypted using the symmetric keys which are held both by the main ECU and the additional ECUs.

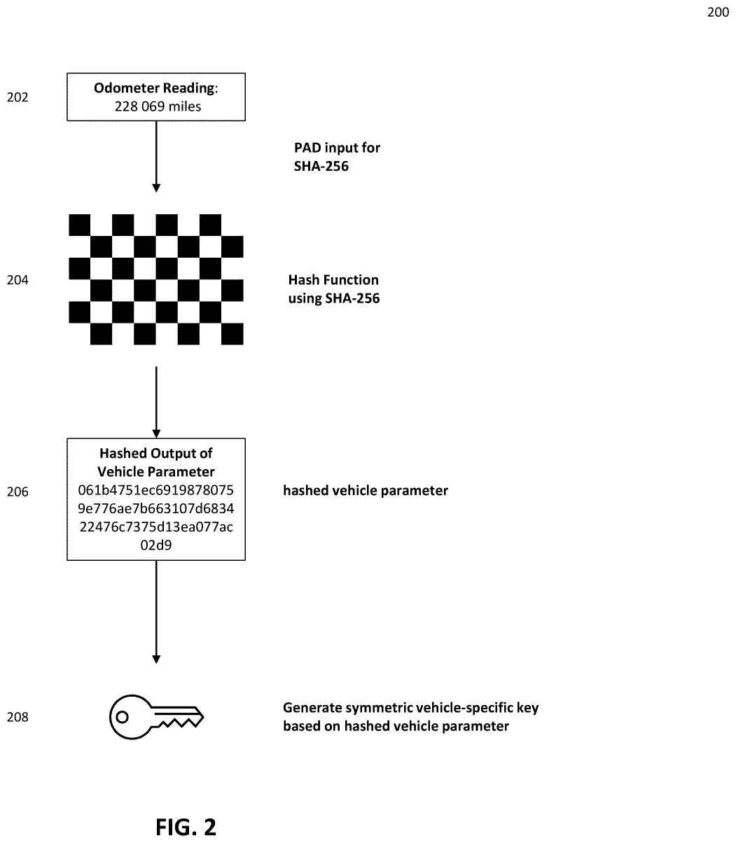

FIG. 2 shows an illustrative scenario 200 of a hashing function to create the vehicle-specific symmetric key, in accordance with some embodiments of this disclosure. This figure illustrates the example mentioned above where, at 202, the odometer reading of 228,069 is padded and seeded into a SHA-256 hash function at 204. The hashed output of the vehicle parameter is shown at 206 which is used to generate the symmetric vehicle-specific key at 208. For example, the hashed output of the vehicle parameter may then be used as a seed to any suitable key generating algorithm. For example, the main ECU may use Advanced Encryption Standard (AES) algorithm with cryptographically secure pseudorandom number generator (CSPRNG) that is seeded with the hash to create a key. Any other suitable key generation standard may be used (e.g., Blowfish, ChaCha20, etc.) or any combination of the above.

In some embodiments, the main ECU may detect a presence of an additional ECU on a vehicle communication network of the vehicle. The vehicle communication network of the vehicle may be any networking hardware that ensures bandwidth and security protocol standards. In some embodiments, the vehicle communication network includes an ethernet bus connecting the main ECU and one or more additional ECUs. The additional ECU includes a FPGA that includes an unprovisioned vehicle control operation. FIG. 1B shows an illustrative scenario 110 where the main ECU detects an additional ECU and generates an encrypted FPGA image, whether a computing set is available to perform the compute task, in accordance with some embodiments of this disclosure. At 112, the main ECU detects an additional ECU on the vehicle communication network (e.g., ethernet bus), namely the Advanced Driver Assistance ECU. The main ECU may generate an FPGA image for the additional ECU. The FPGA image includes configuration data that is loaded onto the FPGA to define its functionality. The data may be a bitstream file that programs the FPGA to perform specific tasks, such as image processing or other compute-intensive operations for the vehicle. The FPGA image may include the symmetric vehicle-specific key. At 114, the main ECU generates the FPGA image that includes the symmetric vehicle-specific key. An FPGA may include an array of programmable logic blocks with a connecting grid, that can be provisioned to interconnect with other logic blocks to perform various digital functions. An FPGA configuration may be written using a hardware description language (HDL) (e.g. VHDL) similar to the ones used for application-specific integrated circuits (ASICs). The logic blocks of an FPGA may be provisioned to perform complex combinational functions, or act as simple logic gates like AND and XOR. In some embodiments, the FPGA logic blocks may include memory elements, which may be simple flip-flops or more sophisticated blocks of memory. FPGAs may be reprogrammed to implement different logic functions, allowing flexible reconfigurable computing as performed in computer software. The main ECU may cryptographically sign the FPGA image using the private key stored in the HSM of the main ECU. Returning to 114, the FPGA image is signed with the main ECU private key.

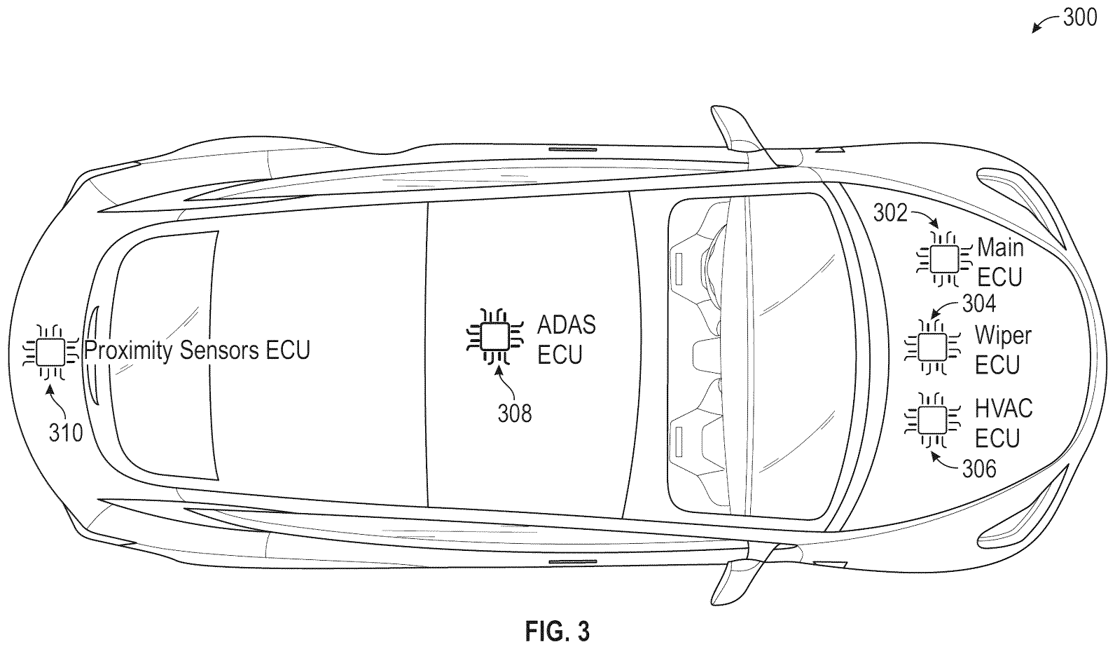

FIG. 3 shows an illustrative scenario 300 of a vehicle including multiple ECUs controlling vehicle operations, in accordance with some embodiments of this disclosure. In particular, the vehicle includes a main ECU (302), a Wiper ECU (304), a HVAC ECU (306), a Advanced Driver Assistance Systems ECU (308), and Proximity Sensors ECU (310). This is an illustrative example of the various types of ECUs a vehicle may have. A vehicle may have more ECUs or ECUs depending on configuration.

In some embodiments, the main ECU may transmit via the vehicle communication network, the signed FPGA image to the additional ECU for installation. The additional ECU is provisioned to verify the signed FPGA image using a public key provided by the certificate authority, and the installation causes the additional ECU provisioned with the FPGA image to perform the vehicle control operations and communicate via the vehicle communication network using the symmetric vehicle-specific key. Returning to FIG. 1B at 116, the signed FPGA image is transmitted from the main ECU to the Advanced Driver Assistance ECU for installation. In some embodiments, the main ECU may perform integrity checks on the transferred data (e.g., the signed FPGA image). The integrity checks may implement checksum functions to verify the integrity of the transferred data.

FIG. 1C shows an illustrative scenario 120 where the additional ECU verifies the signature of the FPGA image and installs the FPGA image, in accordance with some embodiments of this disclosure. The additional ECU, namely the Advanced Driver Assistance ECU, receives the public key from the certificate authority (e.g., the vehicle manufacturer). The Advanced Driver Assistance ECU verifies the digital signature of the main ECU by decrypting the encryption performed by the main ECU private key using the public key received from the vehicle manufacturer. Upon successful verification, the Advanced Driver Assistance ECU installs the FPGA image which causes the symmetric vehicle-specific key to be stored within the respective HSM of the Advanced Driver Assistance ECU.

FIG. 1D shows an illustrative scenario 130 where the main ECU and additional ECU transfer data over the ethernet bus using the vehicle-specific symmetric key, in accordance with some embodiments of this disclosure. The additional ECU, namely the Advanced Driver Assistance ECU, transmits encrypted data to the main ECU via the ethernet bus at 132. The encryption on the data by the Advanced Driver Assistance ECU is implemented using the vehicle-specific symmetric key. Moreover, the decryption by the main ECU of the data received is decrypted using the same vehicle-specific symmetric key.

In some embodiments, the additional ECU is pre-provisioned with a provisional FPGA image that enables the additional ECU to perform networking and cryptographic operations and does not enable the additional ECU to perform the vehicle control operations. The additional ECU may receive the public key from the certificate authority using the provisional FPGA image and verify the signed FPGA image based at least in part on decrypting a signature of the FPGA image that was signed using the private key. This is similar to the example above where the additional ECU may decrypt the signature that was signed by the main ECU using the main ECU private key by using the corresponding public key received from the certificate authority. In yet other embodiments, the main ECU may transmit to the additional ECU a provisional FPGA image that when installed by the additional ECU that enables the additional ECU to perform networking and cryptographic operations and does not enable the additional ECU to perform the vehicle control operations. The additional ECU may then receive the public key from the certificate authority using the provisional FPGA image and verify the signed FPGA image based at least in part on decrypting a signature of the FPGA image that was signed using the private key.

In some embodiments, the main ECU may determine an expiration date of the signed FPGA image. For example, the expiration date of the signed FPGA image may be Jan. 1, 2025. In response to determining that current date is within a threshold of the expiration date, the main ECU may generate a new FPGA image for the additional ECU, where the new FPGA image comprises a new symmetric vehicle-specific key. Continuing with the example, if the threshold is set to 30 days, and the current date is Dec. 5, 2024, the main ECU determines that the current date is within the threshold of 30 days. The main ECU may cryptographically encrypt the new FPGA image using the symmetric vehicle-specific key. The main ECU may then transmit, via the vehicle communication network, the encrypted new FGPA image to the additional ECU for installation. In some embodiment, new FGPA image may be both encrypted with the old symmetric key and signed with the private key of the main ECU, in which case it will be verified (e.g., as described in FIGS. 1A-D). The additional ECU is provisioned to decrypt the encrypted new FPGA image using the symmetric vehicle-specific key previously stored as part of installation of the FPGA image. The installation of the new FPGA image also causes the additional ECU to perform the vehicle control operations using the new symmetric vehicle-specific key. In some embodiments, the symmetric vehicle-specific key for the additional ECU at the expiration date is revoked (e.g., after Jan. 1, 2025, the symmetric vehicle-specific key is revoked and only the new symmetric vehicle-specific key remains.) In some embodiments, the main ECU may configure for the vehicle communication network a plurality of virtual local area networks (VLANs). The main ECU may configure a first subset of ECUs of the vehicle to communicate via a first VLAN of the plurality of VLANs, where the first subset of ECUs are provisioned to encrypt communications using the symmetric vehicle-specific key. Moreover, the main ECU may also configure a second subset of ECUs of the vehicle to communicate via a second VLAN of the plurality of VLANs, wherein the second subset of ECUs are provisioned to encrypt communications using an additional symmetric vehicle-specific key based on at least one additional vehicle parameter of the vehicle different from the at least one vehicle parameter of the vehicle used to generate the symmetric vehicle-specific key. In some embodiments, the main ECU may generate a VLAN 1 symmetric vehicle-specific key that is specific to the first VLAN and a VLAN 2 symmetric vehicle-specific key that is specific to the second VLAN. In this configuration, only VLAN 1 symmetric vehicle-specific key can be used for encryption and decryption for the first VLAN, and similarly only VLAN 2 symmetric vehicle-specific key can be used for encryption and decryption for the second VLAN. Even though the same vehicle communication network (e.g., ethernet) is used, the distinct VLANs allow for separate secure communication channels for each respective VLANs having respective ECUs assigned to each VLAN. For example, all ECUs may listen on the vehicle communication network for all packets, but packets/frames for a different VLAN (e.g., with the wrong header) than the ECU is assigned are ignored. Moreover, even if they were not ignored, the packets would not be able to be decrypted because the ECUs lack the VLAN symmetric vehicle-specific key for the specific VLAN that they are not assigned.

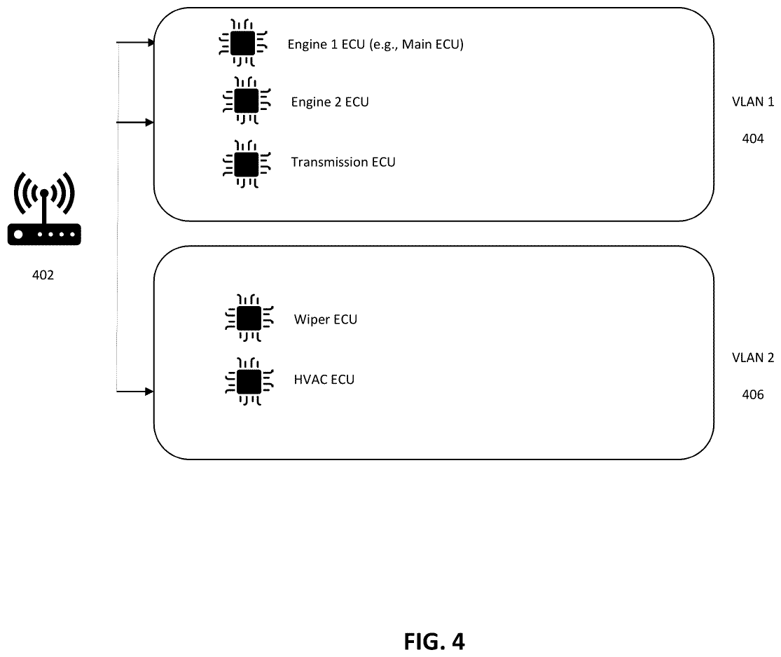

FIG. 4 shows an illustrative scenario 400 of multiple virtual local area networks implemented on the vehicle communication network, in accordance with some embodiments of this disclosure. In this example, a networking managing device 402 (e.g., the main ECU) may create multiple virtual local area networks including VLAN 1 (404) and VLAN 2 (406). VLAN 1 includes a number of ECUs such as the Engine 1 ECU, the Engine 2 ECU, and the Transmission ECU. VLAN 2 includes a number of ECUs such as a Wiper ECU and an HVAC ECU. Each of the VLANs communicate on separate virtual networks and communication cannot take place outside of the VLAN. For example, the Wiper ECU may communicate with the HVAC ECU as both ECUs are on VLAN 2. However, the Wiper ECU cannot communicate with the Transmission ECU as both of the ECUs are on separate VLANs.

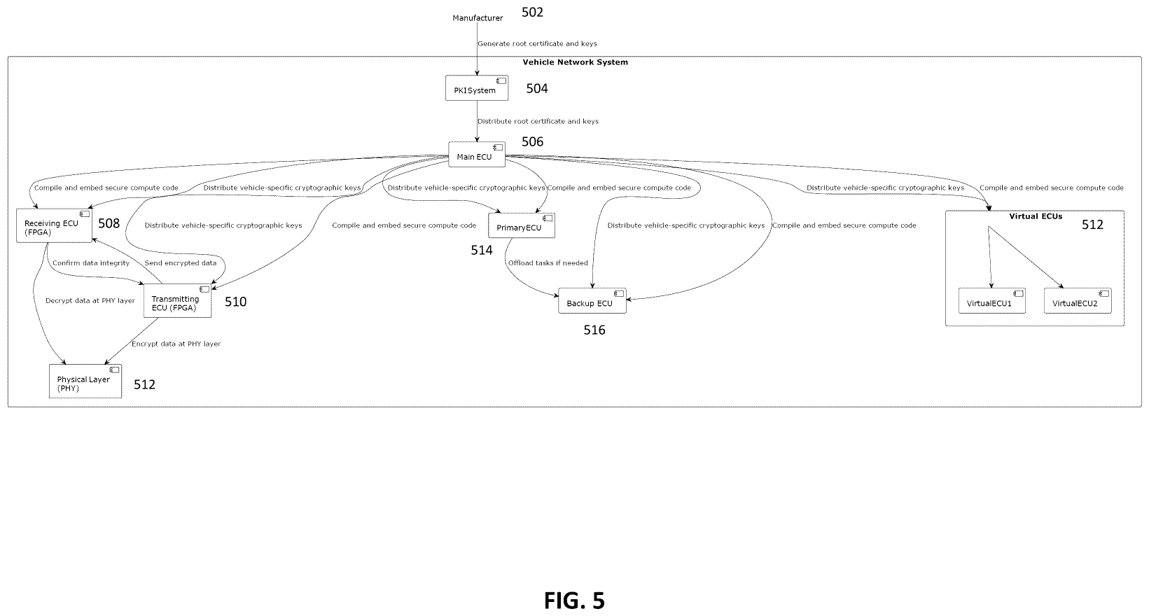

FIG. 5 shows an illustrative scenario of a system diagram 500 of a main ECU, additional ECUs, and a Certificate Authority that is a vehicle manufacturer, in accordance with some embodiments of this disclosure. In some embodiments, a certificate authority that may be vehicle manufacturer (502) generates root certificate and keys, through a Public Key Infrastructure (PKI) at 504 for a main ECU (506) similar to FIG. 1A at 102. The generation of encryption keys may use various parameters of the vehicle as inputs to the seed such as the Vehicle Identification Number (VIN), the number of miles on the odometer, or other information which may be used to randomize a cryptographic seed, ensuring that the encryption process is unique to each vehicle, similar to FIG. 1A at 104-108. Following this, data intended for transmission across the vehicle communication network is encrypted using the on-vehicle generated keys, which guarantees that the data remains confidential and can only be decrypted by entities possessing the correct keys.

To ensure the data has not been tampered with during transmission, integrity checks such as checksums or cryptographic hashes are applied. These checks may also utilize aspects of the VIN to enhance security, ensuring that the integrity verification process is as personalized as the encryption. The FPGA compiled firmware could implement protocols such as Public Key Infrastructure (PKI) where the device's public key, signed by a trusted authority (potentially the vehicle manufacturer), may be used to authenticate devices. The secure compute component may verify the signature against its compiled cryptographic keys to authenticate the device's identity securely.

Once prepared, the encrypted and integrity-protected data is transmitted over vehicle communication network to a receiving ECU (508) and transmitting ECU (510), similar to FIG. 1B at 112-114. The physical layer (512) security measures of ethernet ensure that the data is robust against eavesdropping and physical tampering. Upon data receipt, the system authenticates the sending and receiving devices based on credentials that include the vehicle specific cryptographic keys or VIN-specific parameters. This step is critical as it prevents unauthorized devices from accessing the network and ensures that communication is only between trusted devices.

Following authentication, the data is decrypted using the vehicle specific cryptographic keys, a crucial step to transform the data back into its original, usable form. A similar process can be seen in FIG. 1C at 122-126. Simultaneously, the integrity of the data is verified using the earlier applied checks. Any discrepancy triggers security protocols, such as alerting the system to potential data corruption or unauthorized tampering. Access control mechanisms then ensure that only authorized commands and data requests are executed, based on policies that utilize the vehicle specific cryptographic keys for enhanced security, similar to FIG. 1D at 132. Commands that pass all security checks are subsequently executed, which can involve anything from routine operations to configuration changes in the vehicle's system.

Before an ECU or device starts communication over the network, the FPGA's secure compute component engages in a cryptographic handshake using its compiled keys. This handshake can confirm the identity of the device based on cryptographic proofs rather than relying solely on physical identifiers like MAC addresses. The secure compute component within the FPGA can generate and exchange temporary session keys based on its pre-compiled keys for each session. This dynamic key exchange can be part of a more extensive key-based authentication protocol, ensuring that only currently authorized devices can communicate on the network.

The secure compute component can manage access control lists (ACLs) dynamically based on the cryptographic identity and current vehicle state. This can determine which ECUs have access to specific network resources and what actions they are authorized to perform, enhancing the port-based Network Access Control (PNAC).

In some embodiments, the main ECU (506) may distribute vehicle-specific symmetric keys to compile and embed secure compute code in the primary ECU (514) and backup ECU (516). The primary ECU may perform load balancing with a backup ECU and offload tasks if needed.

In some embodiments, the FPGA can facilitate the creation of virtual LANs (VLANs) 512 or separate network segments where communication is restricted to specific groups of ECUs. By using cryptographic keys to define and enforce these segments, the secure compute component ensures that even if unauthorized access occurs, it is contained within a limited segment.

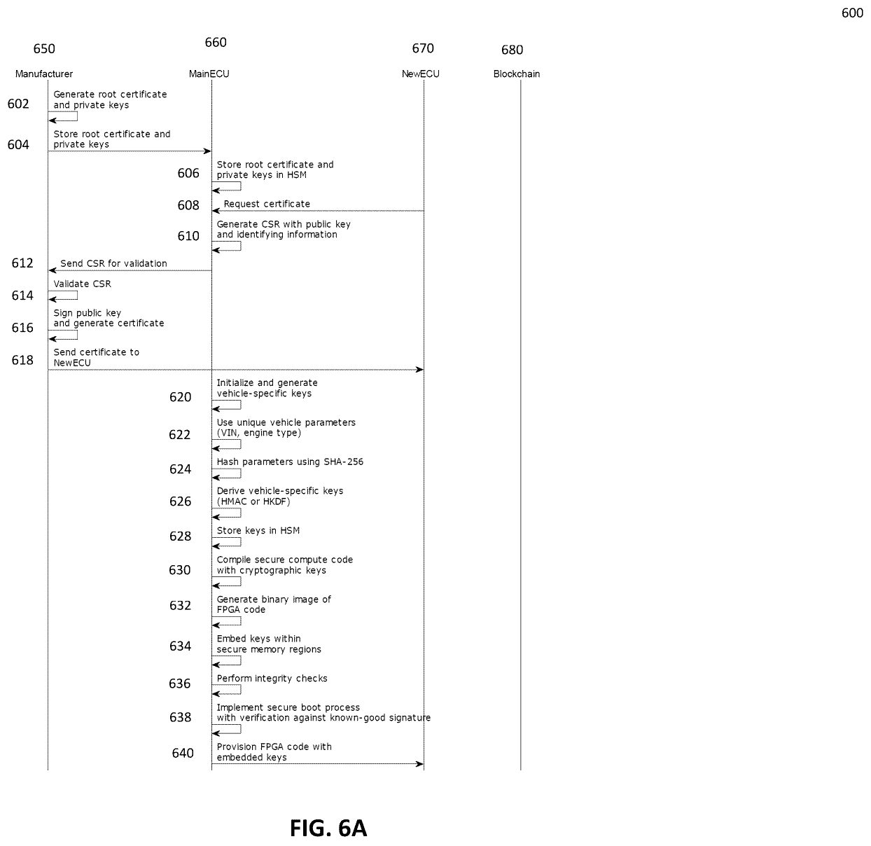

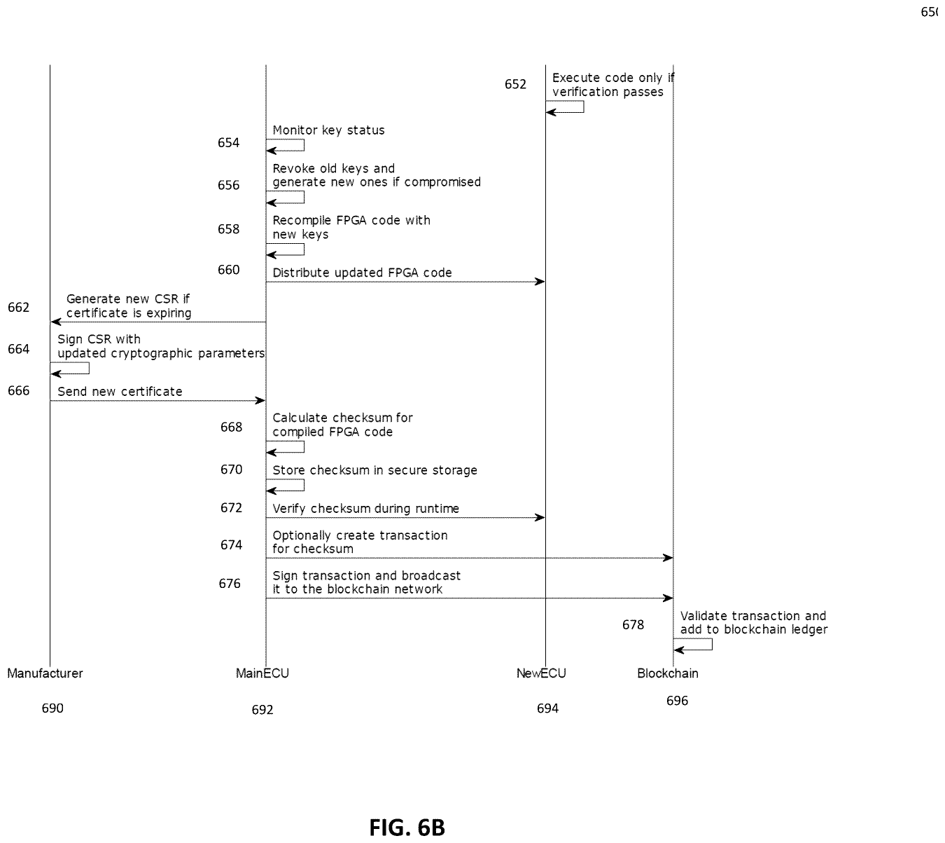

FIG. 6A shows an illustrative scenario 600 of a flow diagram of confirming secure configuration of an additional ECU, in accordance with some embodiments of this disclosure. In some embodiments, the main ECU implements Public Key Infrastructure (PKI) architecture. A certificate authority, such as the vehicle manufacturer 650, may generate a vehicle-specific set of cryptographic keys. Initially, the vehicle manufacturer generates a root certificate and corresponding private keys (602), which are securely stored within the main ECU (604) similar to the process shown in FIG. 1A at 102 and 104. These keys are used to sign the public keys of the main ECU and/or additional ECUs within the vehicle, establishing a hierarchical trust model that certifies the identity and cryptographic credentials of the main ECU 660, verified and backed by the manufacturer.

The vehicle manufacturer may generate the root certificate using a secure certificate authority (CA) infrastructure. The root certificate, which includes the public key, is stored in a secure repository, while the corresponding private key is maintained within a high-assurance HSM to ensure its integrity and security (606). The main ECU, equipped with a HSM or a secure enclave, securely stores these cryptographic keys.

When an additional ECU (e.g., new ECU) 670 is introduced into the vehicle, the additional ECU may request a certificate from the main ECU (608). The main ECU generates a certificate signing request (CSR) that includes its public key and other identifying information (610). The CSR is signed by the main ECU's private key and sent to the manufacturer's CA for validation and certificate issuance (612). Upon validation (614), the CA signs the additional ECU controller's public key, generating a certificate (616) that is sent back to the additional ECU controller (618), thus completing the trust chain.

Subsequently, the main ECU controller may initialize and generate a set of vehicle-specific cryptographic keys (620). The generation may implement using unique vehicle parameters such as the vehicle identification number (VIN), engine type, and other vehicle parameters (622), which are combined in a cryptographic algorithm to ensure the uniqueness of the keys. These parameters are hashed using a secure hashing algorithm such as SHA-256 (624), and the resulting hash value is used as an input to a cryptographic key generation function (e.g., HMAC or HKDF) to derive the vehicle-specific symmetric key (626). These vehicle-specific symmetric key is then securely stored within the main ECU's HSM (628), which provides tamper-resistant storage and prevents unauthorized access.

The main ECU may compile these vehicle-specific symmetric key into the secure compute component (630), which is part of the FPGA code provisioned into other vehicle ECUs as needed. This process may involve generating a binary image of the FPGA code (632), embedding the vehicle-specific symmetric key within secure memory regions of the FPGA, and performing integrity checks. This compilation process may involve embedding the vehicle-specific symmetric key within secure memory regions of the FPGA code (634), ensuring that the keys are an integral part of the ECU's operational logic. Integrity checks may be performed to verify the FGPA image (636). Additionally, a secure boot process may be implemented, wherein the FPGA code, including the embedded keys, is verified against a known-good signature before execution (638). This ensures that only authenticated and unaltered code is executed by the ECUs, preventing potential security breaches from tampered or malicious code.

In some embodiments, dynamic key management may be implemented. If a vehicle-specific symmetric key is compromised or reaches the end of its validity period, the main ECU can revoke the old vehicle-specific symmetric key and generate new vehicle-specific symmetric key. The new keys are then recompiled into the FPGA code and securely distributed to the respective additional ECUs (640).

FIG. 6B shows a continued illustrative scenario of a flow diagram 650 of confirming secure configuration of an additional ECU, in accordance with some embodiments of this disclosure. This process is supported by the PKI system, ensuring that all updates and revocations are securely signed and verifiable. A secure boot process ensures that the FPGA code is only executed if it passes verification against a known-good signature (652). During monitoring (654), if a vehicle-specific symmetric key is compromised or reaches the end of its validity period, the main ECU may revoke this vehicle-specific symmetric key (656) by updating the FPGA code with a new vehicle-specific symmetric key (658). The updated FPGA code may be distributed to the new ECU (658). The key management process is supported by the PKI system, where updates or revocations are securely signed using the manufacturer's CA private key and can be verified by all relevant parties using the corresponding public key.

If the additional ECU's certificate is nearing expiration or requires updating of its cryptographic parameters, the manufacturer can issue a new certificate. This process involves generating a new CSR with updated cryptographic parameters (662), signing it with the manufacturer's CA private key (664), and securely deploying the new certificate to the vehicle via encrypted communication channels (666). To ensure the integrity and security of the compiled FPGA ECU code, a checksum for each compiled additional ECU FPGA code may be calculated immediately after code compilation using a cryptographic hash function (668). These checksums may be stored within the additional ECU's secure storage (670) and can be verified during runtime to detect any unauthorized modifications (672).

In some embodiments, the checksums may be integrated into a decentralized blockchain 680, providing an immutable record of the FPGA code's integrity and enhancing the overall security of the system by enabling decentralized verification. For example, if an odometer is altered nefariously, the only medium that needs to be altered is the odometer. However, if the odometer record is recorded on the blockchain through a vehicle-specific symmetric key based on the odometer reading, a record of this key on the central ledger is copied on multiple records within the blockchain. Thus, the difficulty of conducting any nefarious activity increases by many magnitudes. This blockchain integration involves creating a transaction for each checksum (674), signing it with the main ECU's private key, and broadcasting it to the blockchain network (676), where it is validated and added to the blockchain ledger (678).

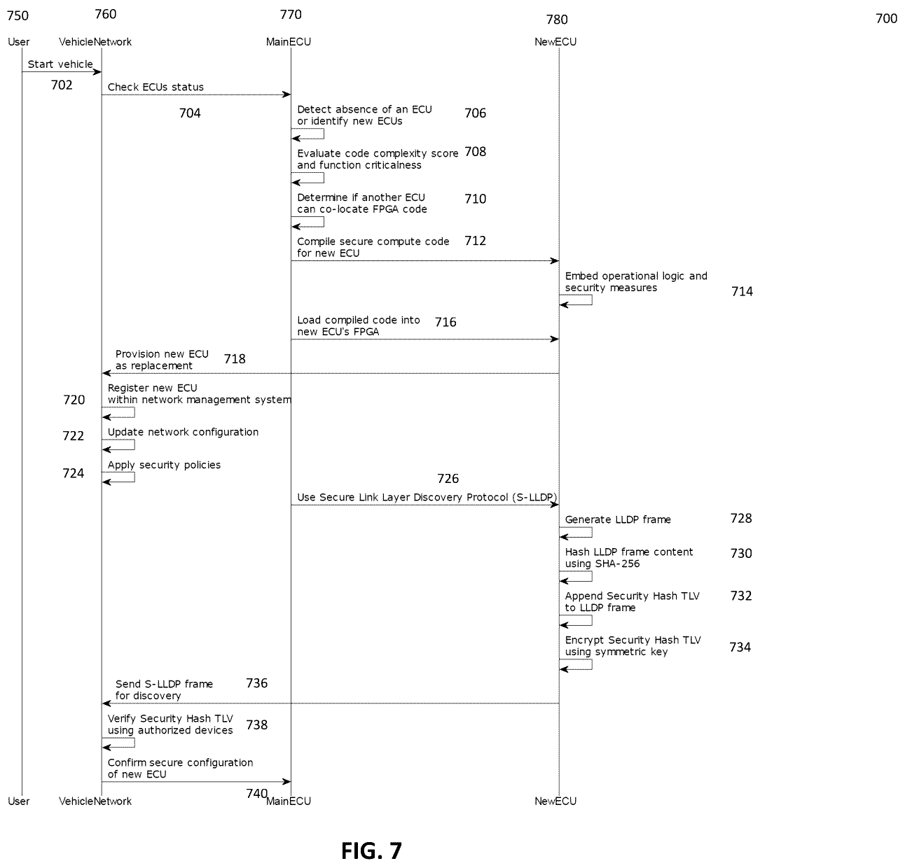

FIG. 7 shows an illustrative scenario 700 of a flow diagram of confirming secure configuration of an additional ECU, in accordance with some embodiments of this disclosure. The main ECU dynamically detects, provisions, and configures new or replacement Electronic Control Units (ECUs) within a vehicle's network. Upon vehicle startup (702) by a user (750) or during operation (704), the main ECU (770) automatically detects the absence of an ECU (706) and identifies any new, unknown ECUs that have been installed. For example, if the main ECU detects a new ECU (780) for controlling wiper fluid is un-responsive, the main ECU could determine, at 708, (based on a code complexity score calculated during compilation time and considering the criticalness of the function on both ECUs) if another ECU is a candidate for co-locating the FPGA code for both the working ECU function (for example, a rear window wiper control) and the unresponsive ECU (the wiper fluid controller) or replacing the code with a more critical function at 710.

At 712, the configuration may involve compiling the latest secure compute code into the FPGA of the new ECU. This secure compute code includes both the operational logic necessary for the specific vehicle function—such as controlling the windshield wiper fluid—and integrated security measures. These security measures are derived from a vehicle-specific symmetric key that ensures any operation by the ECU (main or new) is authenticated and secure. At 714, operational logic and security measures may be embedded onto the FPGA as well.

Once the code is successfully compiled and loaded into the new ECU at 716, the main ECU may fully provision the new ECU as the designated replacement for the failed unit at 718 via the vehicle network 760. Provisioning may include registering the ECU within the vehicle's network management main ECU at 720, updating network configuration to recognize the new ECU at 722, and applying any required security policies or settings at 724. This ensures that the new ECU is not just a functional replacement but is also secure and compliant with the vehicle's cybersecurity protocols.

When the ECU needs to be discovered, the main ECU may use an enhanced version of Link Layer Discovery Protocol (LLDP) which is disclosed herein. This new secure LLDP or S-LLDP may be implemented as follows at 726: as part of the LLDP frame generation process 728, a secure hash algorithm (e.g., SHA-256) may be used (730) to create a hash of the frame's content. This hash acts as a digital fingerprint of the frame's data at the time of its creation. The data hashed typically includes all the TLVs (Type-Length-Value elements) that LLDP uses to convey information about the device, its capabilities, and other attributes. The generated hash is then appended to the LLDP frame as a new custom TLV (732), specifically designed for this purpose. This TLV may be termed the “Security Hash TLV,” uniquely identifying it as part of the security enhancements. To protect the hash itself, the TLV could be encrypted using the symmetric vehicle-specific key 734, ensuring that only authorized devices within the specific vehicle may verify the hash. The main ECU may then send the S-LLDP frame for discovery (736) and may verify the security hash TLV using authorized devices (738) to confirm the new secure configuration of the new additional ECU (740).

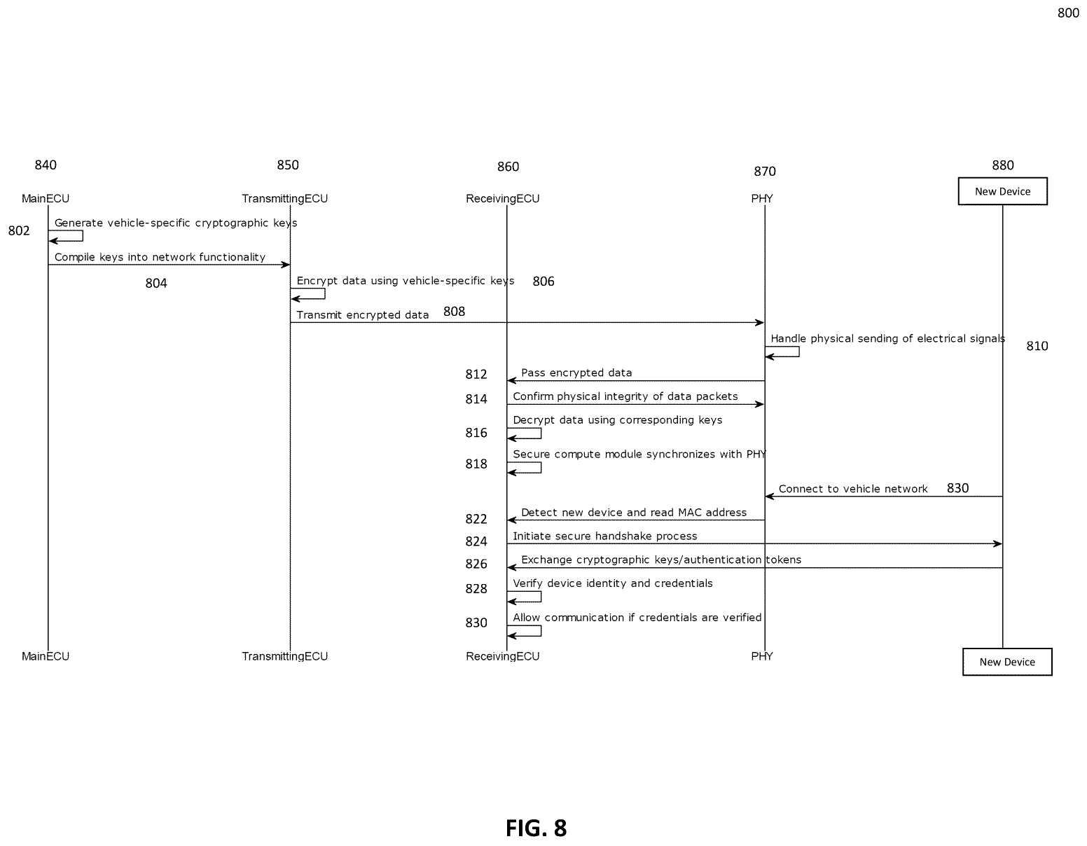

FIG. 8 shows an illustrative scenario 800 of a flow diagram of allowing communication if credentials are valid of an additional ECU, in accordance with some embodiments of this disclosure. In some embodiments, the integration of vehicle-specific symmetric key and secure compute functionalities within an Electronic Control Unit (ECU) may be linked to the physical layer (PHY) of the vehicle communication network (e.g., ethernet) to enhance the security protocols employed in vehicle networks.

The main ECU (840) generates vehicle-specific cryptographic keys (802) and may compile the vehicle-specific symmetric key into the network functionality for each of the vehicle's additional ECUs (804), similar to FIG. 1B at 112-116. As the data is transmitted via the transmitting ECU (850) and arrives at the PHY layer, which is responsible for the actual sending and receiving of electrical signals over the vehicle's network physical medium, the ECUs secure compute component encrypts the data (808). The physical layer handles the transmission of electrical signals (810). The exempted data is passed from the physical layer to the receiving ECU (812).

Upon receiving data, a receiving ECU 860 (e.g., an additional ECU), may decrypt the data string using the vehicle-specific symmetric key at the PHY layer (816), similar to FIG. 1C at 122-126. This step occurs after the PHY 870 confirms the physical integrity of the incoming data packets (814), effectively marrying hardware-level security checks with data-level encryption protocols. The secure compute module, therefore, not only oversees the encryption and decryption processes but also ensures these are synchronized with the physical handling of data by the PHY (818).

To establish secure communication sessions when new devices 880 or ECUs are connected to the network (830), the secure compute module utilizes the PHY layer's capabilities to manage a secure handshake process (824). This involves the exchange of the vehicle-specific symmetric key or authentication tokens (826), crucial for verifying the identities of the devices connected to the network, similar to FIG. 1D at 132. Additionally, the module uses PHY's ability to detect connected devices (e.g., via MAC addresses (822)) to implement security protocols that ensure only devices with verified identities (828) and appropriate credentials are allowed to communicate over the network (830).

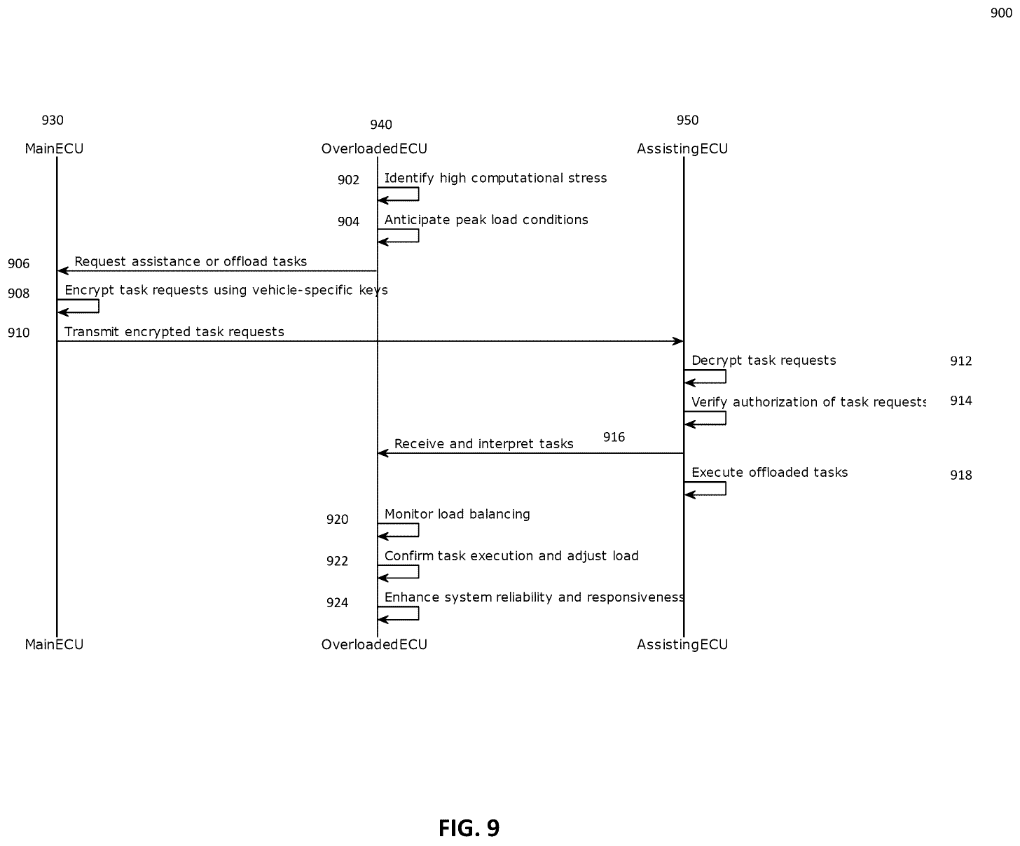

FIG. 9 shows an illustrative scenario 900 of a flow diagram of main ECU (930) load balancing tasks from an overloaded ECU (940) to an additional assisting ECU (950), in accordance with some embodiments of this disclosure. In some embodiments, when an ECU (e.g., main or additional) identifies high computational stress (902) or anticipates peak load conditions (904), such as during high-speed driving or complex maneuvering, the ECU may request assistance or offload tasks to additional ECUs within the network (906).

This load balancing helps prevent ECU overloading and potential system failure, thus enhancing the reliability and responsiveness of the vehicle's systems. The encryption of task requests (908) ensures that only authorized ECUs can receive at 910 (as described in previous embodiments), interpret, and respond to these requests, safeguarding against unauthorized data interception and ensuring system integrity. At 912, the assisting ECU may decrypt the task request and verify authorization of the task request (914) and transmit the communication back to the overloaded ECU (916) to confirm interpretation of the task to execute. At 918, the assisting ECU may execute the offloaded task. The overloaded ECU may continue to monitor load balancing (920) and confirm the task execution by the assisting ECU (922) to confirm that the system has enhanced reliability and responsiveness (924).

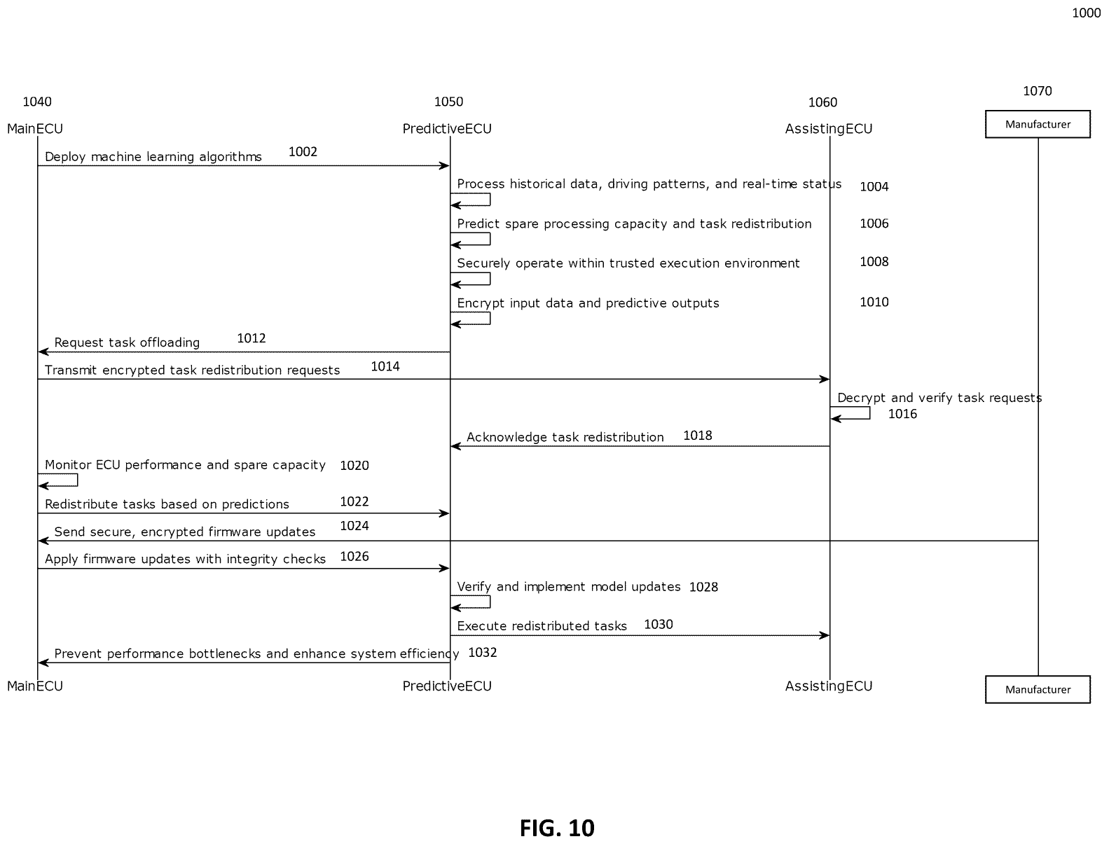

FIG. 10 shows an illustrative scenario of a flow diagram 1000 of main ECU (1040) implementing a predictive additional ECU (1050), in accordance with some embodiments of this disclosure. In some embodiments, the system employs machine learning algorithms (1002) to predictively manage the allocation of tasks among ECUs based on a combination of historical data, driving patterns, and real-time vehicle status 1004. By processing this data, the algorithms can determine when ECUs are likely to have spare processing capacity and redistribute tasks accordingly before performance bottlenecks occur 1006. The operation of these machine learning algorithms is secured within the secure compute component (a trusted execution environment) on each ECU 1008, ensuring that both the input data and the predictive outputs are shielded from unauthorized access 1010. Updates to these machine learning models may be performed through secure, encrypted firmware updates that include integrity checks, preventing the injection of malicious code or data corruption.

The predictive ECU may request task offloading to the main ECU (1012). The main ECU may then transmit an encrypted task redistribution request to the assisting ECU (1014) which is decrypted by the assisting ECU 1060 (1016). The predictive ECU acknowledges the task redistribution (1018). The main ECU monitors the ECU performance and spare capacity (1020) and redistributes the tasks based on the predictions (1022). The main ECU may receive secure encrypted firmware updates from the manufacturer (e.g., certificate authority 1070) (1024) and applies them with integrity checks (1026). The predictive ECU may then verify and implement the model updates (1028) and execute the redistributed tasks (1030) and prevent performance bottlenecks and enhance system efficiency (1032).

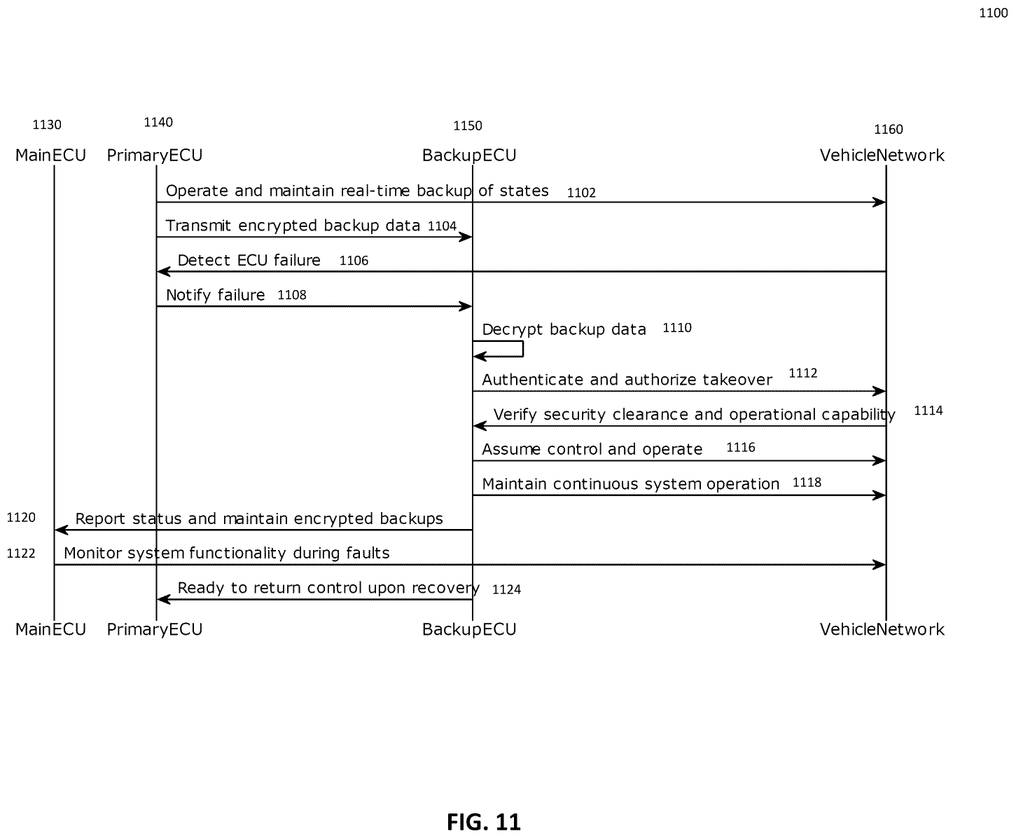

FIG. 11 shows an illustrative scenario 1100 of a flow diagram of main ECU (1130) implementing a backup additional ECU (1150), in accordance with some embodiments of this disclosure. In some embodiments, the system enhances fault tolerance by enabling additional ECUs to temporarily take over the functions of a failed ECU. This seamless transfer of control is governed by pre-provisioned fallback protocols that activate automatically upon detecting an ECU failure.

Security measures are ingrained in this process where each ECU maintains a real-time backup of its operational states and configurations in encrypted form (1102). Encrypted backup data may be transmitted from the primary ECU (1140) to the backup ECU (1104) over the vehicle communication network (1160). Upon the detection of an ECU failure (1106) at the primary ECU, the primary ECU notifies the backup ECU of the failure (1108). When a primary ECU fails, a designated backup ECU decrypts this information and assumes control, ensuring continuous system operation. The transition involves strict authentication and authorization checks, ensuring that only ECUs with the requisite security clearances and operational capabilities can take over, thus maintaining a high level of security and system functionality during faults. The backup data is decrypted at the backup ECU (1110) and an authorized and authenticated takeover takes place (1112). The security clearance and operational capability is verified at the backup ECU (1114) using similar security schemes as stated above (e.g., vehicle-specific symmetric key). The backup ECU assumes control and operates the functions of the primary ECU (1116) to maintain continuous system operation (1118). The main ECU receives reports of the status of the backup ECU (1120) and monitors system functionality during faults (1122). If the primary ECU returns to operational status, the backup ECU may return operations back to the primary ECU (1124).

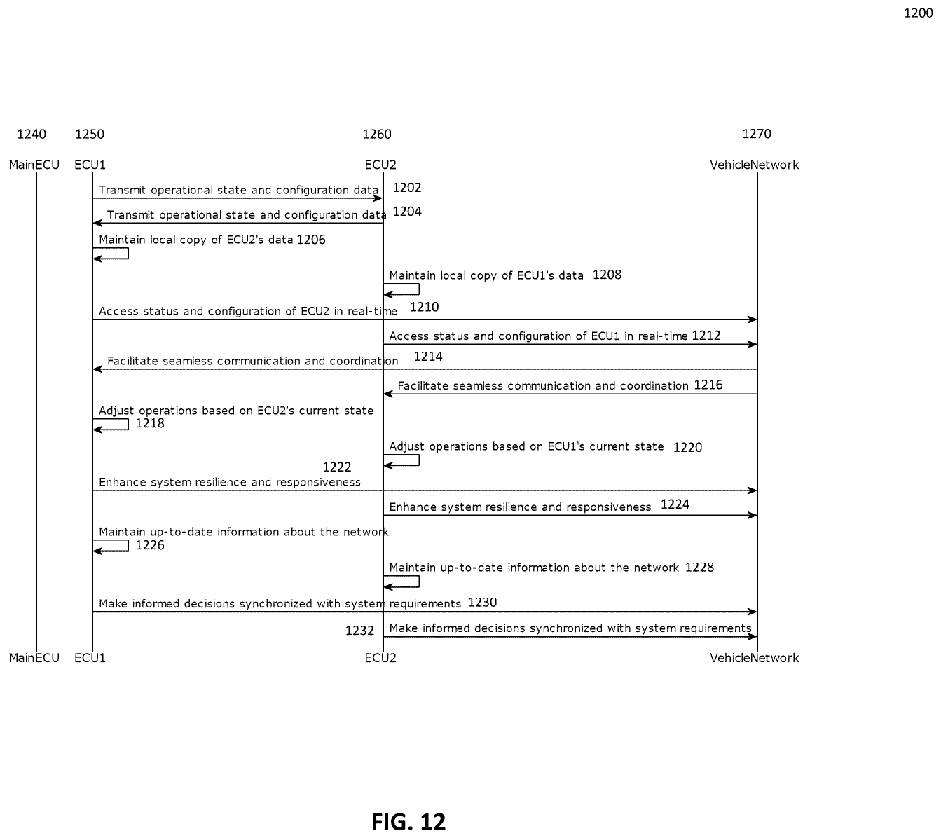

FIG. 12 shows an illustrative scenario of a flow diagram of main ECU (1240) monitoring the operational state of the additional ECU, in accordance with some embodiments of this disclosure. In some embodiments, each ECU maintains a local copy of the operational state and configuration data of the other ECUs. This enables each ECU to have real-time access to the status and configuration of its counterparts, facilitating seamless communication and coordination within the vehicle communication network (1270). This local replication of data ensures that each ECU can dynamically adjust its operations based on the current state of other ECUs, enhancing the overall system's resilience and responsiveness to changes or failures. By maintaining up-to-date information about the entire network, each ECU can make informed decisions and execute commands that are synchronized with the overall system's requirements and conditions. For example, at 1202 ECU 1 (1250) may transmit operational state and configuration data to ECU 2 (1202) and ECU 2 (1260) may transmit operational state and configuration data to ECU 1 (1204). Each respective ECU maintains a copy of the other ECU's data at 1206 and 1208. Each respective ECU accesses the state and configuration data in real time at 1210 and 1212. The vehicle communication network facilitates this access (1216) to adjust operations on the respective ECUs 1218 and 1220. The system resilience and responsiveness for ECU 1 and ECU 2 may be increased at 1222 and 1224. Again, the system is able to maintain up-to-date information about the ECUs on the vehicle communication network at 1226 and 1228 respectively which allows for informed decisions to be synchronized with system requirements at 1230 and 1232.

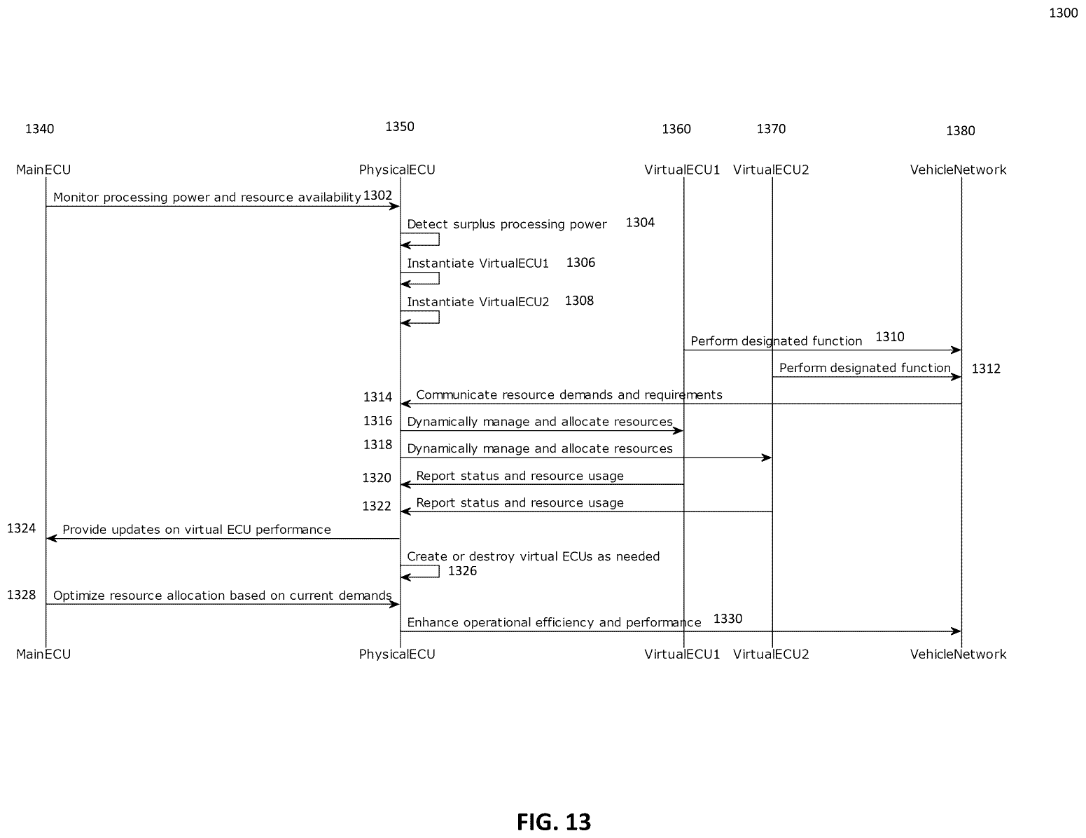

FIG. 13 shows an illustrative scenario of a flow diagram 1300 of main ECU (1340) monitoring the resource availability of the additional ECU, in accordance with some embodiments of this disclosure. In an embodiment, virtual ECUs are employed, where multiple virtual ECUs are instantiated within a single physical ECU (1350). This approach allows for greater flexibility and utilization of available resources. For instance, if an ECU has surplus processing power, it could host multiple virtual ECUs, each responsible for different functions. This virtualization would be managed dynamically, with the system creating or destroying virtual ECUs as needed. This dynamic management ensures that the system can efficiently allocate processing resources based on current demands, optimizing performance and enhancing the overall operational efficiency of the vehicle's electronic systems. For example, the main ECU may monitor the processing power and resource availability 1302 of the physical ECU. The physical ECU may detect a surplus in processing power (1304) and instantiate virtual ECU 1 (1306) and virtual ECU 2 (1308) denoted 1360 and 1370 respectively. Virtual ECUs may perform their respective designated functions at 1310 and 1312, and communicate the resource demands and requirements to the physical ECU at 1314 via the vehicle communication network 1380. The physical ECU may dynamically manage and allocates resources to both virtual ECUs at 1316 and 1318 and receives corresponding status from the virtual ECUs at 1320 and 1322.

The main ECU may receive updates on the virtual ECUs at 1324 and optimize resource allocation accordingly 1328 which enhances the operational efficiency and performance at the physical ECU 1330.

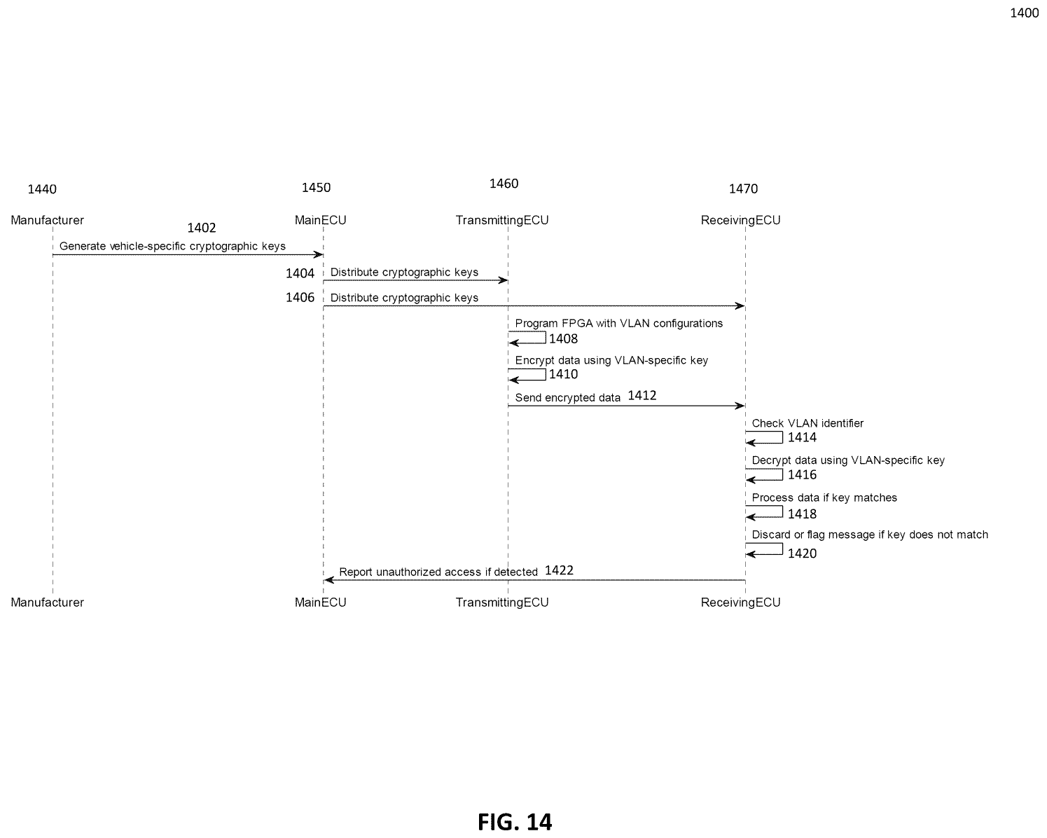

FIG. 14 shows an illustrative scenario 1400 of a flow diagram of main ECU (1450) implementing VLAN configurations, in accordance with some embodiments of this disclosure. In some embodiments, the FPGA (executing code) facilitates the creation of virtual LANs (VLANs) or separate network segments where communication is restricted to specific groups of ECUs. This process starts with the Main ECU generating vehicle-specific symmetric keys (1402) from a private key provided by the manufacturer (1440), which are distributed to the relevant ECUs to define and enforce network segments (1404 and 1406). The FPGA may be programmed with VLAN configuration. Each VLAN or network segment is assigned a unique vehicle-specific symmetric key, ensuring that only ECUs with the correct key can communicate within that segment. The FPGA in each transmitting ECU (1460) is programmed to recognize and adhere to these VLAN configurations (1408). When an ECU sends a message (1412), the secure compute component within its FPGA encrypts the data using the segment-specific cryptographic key (1410). This ensures that the data is tagged with the appropriate VLAN identifier and can only be decrypted by other ECUs within the same segment. Upon receiving a message, the FPGA in the receiving ECU (1470) checks the VLAN identifier (1414) and attempts to decrypt the data (1416) using the corresponding vehicle-specific symmetric key. If the vehicle-specific symmetric key matches, the data is processed (1418); if not, the message is discarded or flagged as unauthorized (1420). This mechanism ensures that even if unauthorized access occurs, it is contained within a limited segment, preventing broader network compromise. In some embodiments, the unauthorized access is reported from the receiving ECU to the main ECU (1422). Additionally, the main ECU monitors the network for any anomalies or unauthorized access attempts. If such events are detected, it can dynamically reconfigure the VLAN assignments or update the cryptographic keys, further enhancing the security and resilience of the network.

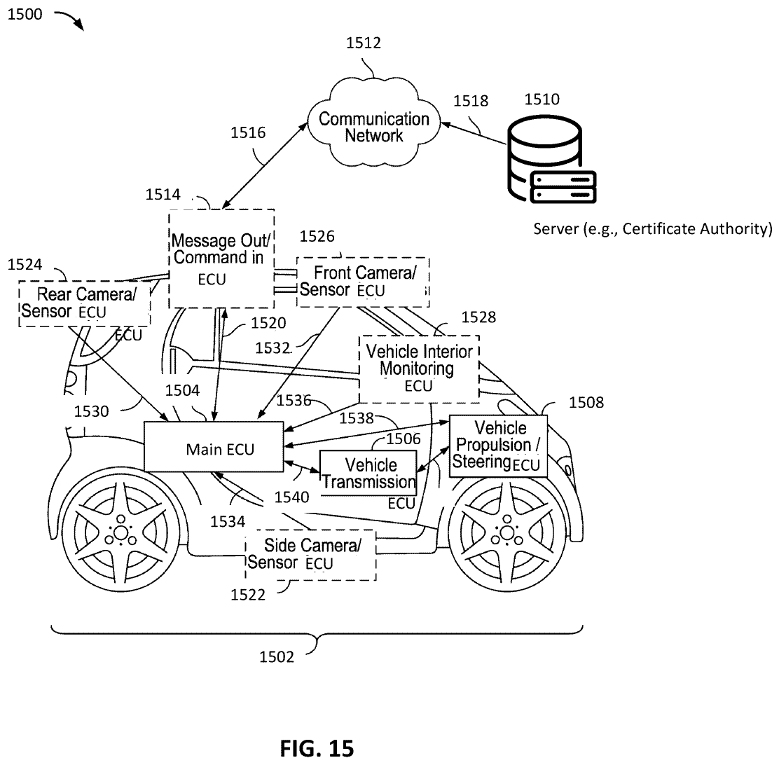

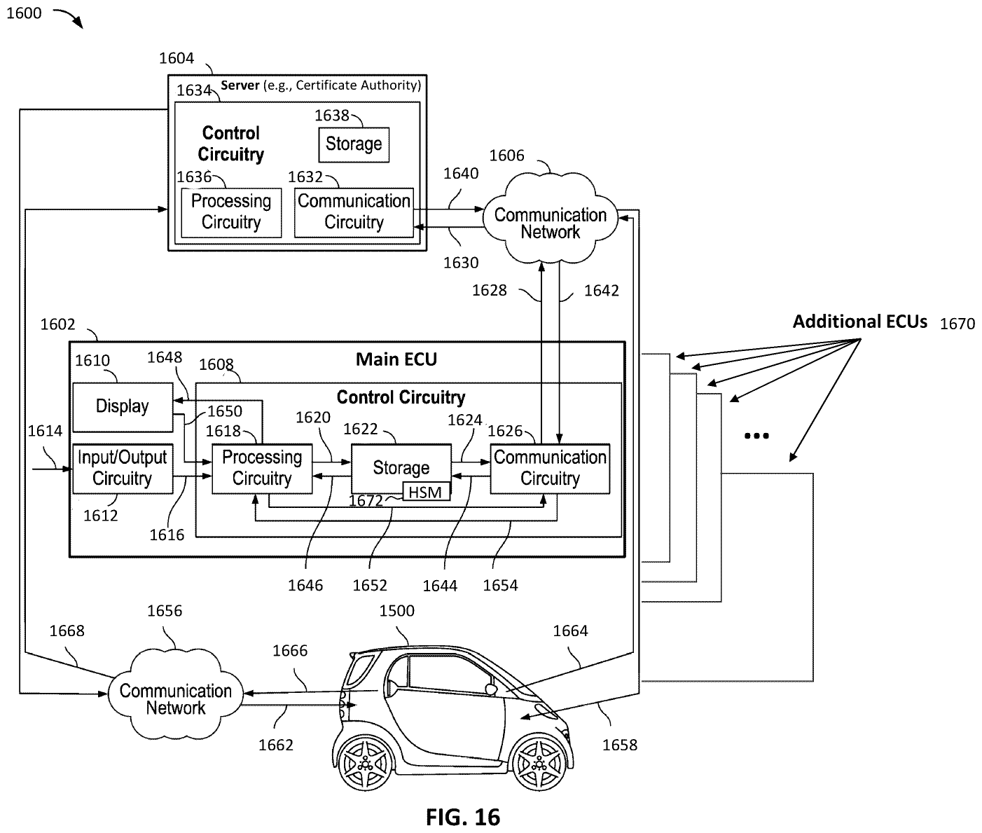

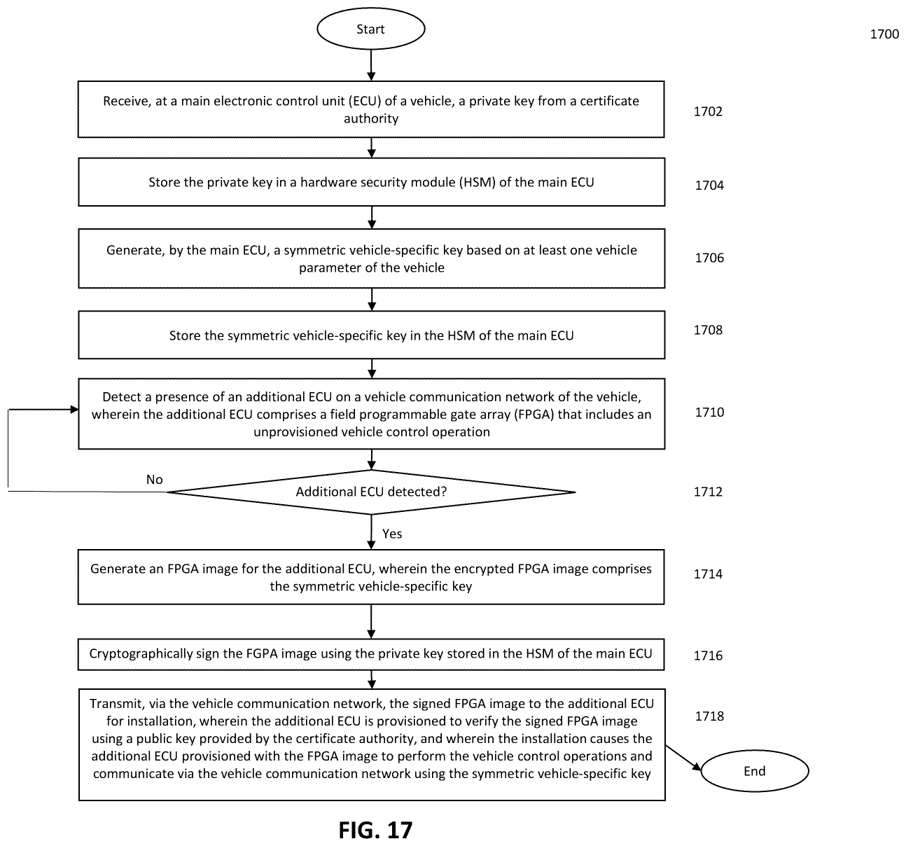

FIG. 15 is a block diagram of an exemplary vehicle system 1500 configured to interface with a system for secure ECU data communication (e.g., stationary vehicle relocation system 1600 of FIG. 16), in accordance with some embodiments of the disclosure. Although vehicle system 1500 depicts certain components and devices, vehicle system 1500 may comprise any or all of the components or device depicted in FIGS. 1-14. Additionally, vehicle system 1500 may be configured to execute any or all of the steps depicted in the methods disclosed in FIGS. 16-17.

Vehicle system 1500 comprises vehicle body 1502. Vehicle body 1502 is configured to enable communication between main ECU 1504, vehicle transmission 1506, and vehicle propulsion/steering ECU 1508. Vehicle processing module 1504 is configured to transmit commands or instructions to various depicted modules, apparatus, and/or circuitries within vehicle body 1502 based on data received from internal and external sources (e.g., from sensor units coupled to the various modules, apparatus, and/or circuitries depicted or from server 1510 which corresponds to main ECU 1602 of FIG. 16). Server 1510 is communicatively coupled or paired with vehicle body 1502, and, more particularly, is configured to transmit and receive data to and from main ECU 1504 via a communication network comprising message out/command in ECU 1514, communication network 1512, and bilateral communication streams 1516 and 1518. For example, main ECU 1504 may comprise computer readable instructions for regulating and initiating autonomous functions of vehicle system 1500. Additionally, server 1510 may be configured to transmit instructions based on user inputs at server 1510 to influence or modify autonomous functions of vehicle system 1500 by transmitting data via communication stream 1518 through communication network 1512 to be received at message out/command in ECU 1514 which translates external messages to a readable medium for main ECU 1504 through vehicle communication network stream 1520.

At least main ECU 1504 is configured to enable a watchdog mode. The watchdog mode is a vehicle state corresponding to vehicle system 1500 that enables main ECU 1504 to process commands in view of data received from various systems within vehicle body 1502 to enable vehicle system 1500 to autonomously move from a first location to a safe location without a vehicle occupant in order to avoid an impending impact. The watchdog mode may be activated via a remote server corresponding to a vehicle relocation service (e.g., as described in reference to FIGS. 1 and 2), may be activated by main ECU 1504, may comprise a separate processing module, and may be activated or modified based on vehicle occupant inputs or user inputs via server 1510.

Main ECU 1504 is integrated into a vehicle communication network configured to transmit messages between the various modules, control circuitries and apparatus. For example, the vehicle communication network may comprise a plurality of wireless or ethernet transmission and reception nodes. The vehicle communication network may comprise a Controller Area Network (hereinafter “CAN bus”), corresponding to a robust vehicle bus standard designed to allow microcontrollers and devices to communicate with each other's applications without a host computer. It is a message-based protocol, designed originally for multiplex electrical wiring within vehicle networks. For each device, the data in a frame is transmitted sequentially but in such a way that if more than one device transmits at the same time, the highest priority device can continue while the others back off (e.g., commands from main ECU 1504 are given higher priority than data received from side camera/sensor ECU 1522. Frames may be received by all devices shown in FIG. 15 or fewer than all devices comprising vehicle system 1500, including by a transmitting device, to determine if transmitted messages or commands are being altered throughout the CAN bus. The amount of data transmitted and received by each device may be a function of the operational protocols of vehicle system 1500 (e.g., certain devices may only have access to a limited portion of the CAN bus to prevent a risk of data or message modification through error stack up during processing).

As shown in FIG. 15, each of rear camera/sensor ECU 1524, side camera/sensor ECU 1522, front camera/sensor ECU 1526, and vehicle interior monitoring ECU 1528 provide data via each of unilateral communication streams 1530, 1532, 1536, and 1534. It is understood that in some embodiments, each of unilateral communication streams 1530, 1532, 1536, and 1534, although not depicted, may comprise bilateral communication streams if each of rear camera/sensor ECU 1524, side camera/sensor ECU 1522, front camera/sensor ECU 1526, and vehicle interior monitoring ECU 1528 comprise modules configured to be in different transmitting and receiving states based on protocols corresponding to individual states of vehicle system 1500 (e.g., in some embodiments, each apparatus may have activation or deactivation protocols as determined by main ECU 1504 depending on which other modules or apparatus in vehicle system 1500 is active or transmitting/receiving data). Each of each of unilateral communication streams 1530, 1532, 1536, and 1534 may comprise security protocols to prevent external or unintended source from modifying or adding signals or data transmitted and received via each communication stream.

Main ECU 1504 is shown having bilateral communication streams 1538 and 1540 coupled to vehicle propulsion/steering ECU 1508 and vehicle transmission ECU 1506, respectively. Each of vehicle propulsion/steering ECU 508 and vehicle transmission ECU 1506 are configured to receive autonomous operation instructions from main ECU 1504 in response to determining a watchdog mode is active and an impending impact requires autonomous operation of vehicle system 1500 (e.g. to move vehicle body 1502 from an original location to a safe location, and, in some embodiments, to return vehicle body 1502 back to the original location once the original location is deemed clear of the impending impact). Additionally, vehicle propulsion/steering ECU 1508 and vehicle transmission ECU 1506 are communicatively coupled on the CAN bus via bilateral communication stream 1512. Bilateral communication streams or unilateral communication streams may comprise security protocols and bus loads contingent on the amount of data that needs to be shared between modules and apparatus depicted in order to adequately and safely enable autonomous functions of vehicle system 1500 (e.g., in the autonomous execution of escape trajectories to avoid impending impacts when no vehicle occupant is present).

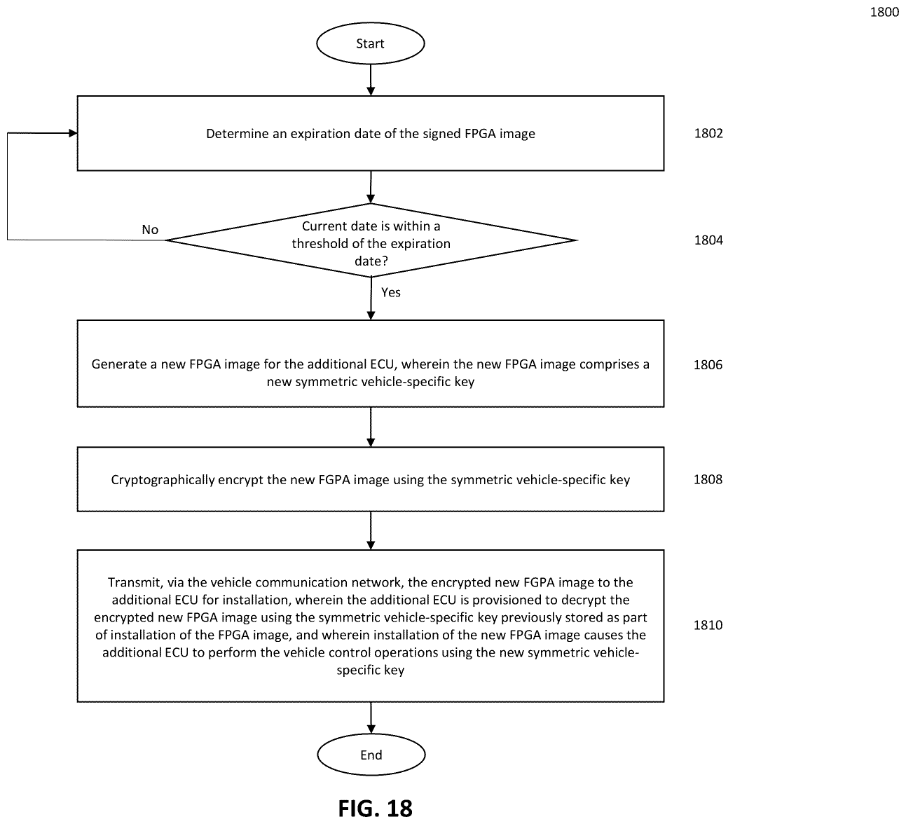

FIG. 16 depicts stationary vehicle relocation system 1600 configured to interface with vehicle system 1500, in accordance with some embodiments of the disclosure. Although stationary vehicle relocation system 1600 depicts certain components and devices, stationary vehicle relocation system 1600 may comprise any or all of the components or device depicted in FIGS. 1-15. Additionally, stationary vehicle relocation system 1600 may be configured to execute any or all of the steps depicted in the methods disclosed in FIGS. 17-18.

Communication networks 1606 and 1656 may include one or more network systems, such as, without limitation, Internet, LAN, Wi-Fi or other network systems suitable for audio processing applications. In some embodiments, the system of FIG. 16 excludes server 1604, and functionality that would otherwise be implemented by server 1604 is instead implemented by other components of the system depicted by FIG. 16, such as one or more components of communication networks 1606 and 1656. In still other embodiments, server 1604 works in conjunction with one or more components of communication networks 1606 and 1656 to implement certain functionality described herein in a distributed or cooperative manner. In some embodiments, the server 1604 may be a certificate authority that implements a public key infrastructure. Similarly, in some embodiments, the system depicted by FIG. 16 excludes main ECU 1602, and functionality that would otherwise be implemented by main ECU 1602 is instead implemented by other components of the system depicted by FIG. 16, such as one or more components of communication networks 1606 and 1656 or server 1604 or a combination of the same. In other embodiments, main ECU 1602 works in conjunction with one or more components of communication networks 1606 and 1656 or server 1604 to implement certain functionality described herein in a distributed or cooperative manner. In some embodiments, all communications may occur over a single communication network (e.g., communication network 1606 or communication network 1656). Features and operations described herein in connection with communication networks 1606 and 1656 may be performed by either communication network 1606 or communication network 1656.

Main ECU 1602 includes control circuitry 1608, display 1610 and input/output circuitry 1612. Control circuitry 1608 may be based on any suitable processing circuitry and includes control circuits and memory circuits, which may be disposed on a single integrated circuit or may be discrete components. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Some control circuits may be implemented in hardware, firmware, or software. Control circuitry 1608 in turn includes communication circuitry 1626, storage 1622 and processing circuitry 1618. In some embodiments, the storage 1622 includes a HSM 1672 to store cryptographic keys (e.g., private keys or vehicle-specific symmetric key).

In addition to control circuitry 1608 and 1634, main ECU 1602 and server 1604 may each include storage (storage 1622, and storage 1638, respectively). Each of storages 1622 and 1638 may be an electronic storage device. As referred to herein, the phrase “electronic storage device” or “storage device” should be understood to mean any device for storing electronic data, computer software, or firmware, such as random-access memory, read-only memory, hard drives, optical drives, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each of storage 1622 and 1638 may be used to store various types of content, metadata, and/or other types of data (e.g., they can be used to record audio questions asked by one or more participants connected to a conference). Non-volatile memory may also be used (e.g., to launch a boot-up routine and other instructions). Cloud-based storage may be used to supplement storages 1622 and 1638 or instead of storages 1622 and 1638. In some embodiments, a user profile and messages corresponding to a chain of communication may be stored in one or more of storages 1622 and 1638. In some embodiments, one or more additional ECUs may be implemented 1670 that perform one or more subsystems of the vehicle 1500. Each additional ECU includes similar components of the main ECU including respective control circuitries, displays, and input/output circuitries.

In some embodiments, control circuitry 1608 and/or 1634 executes instructions for an application stored in memory (e.g., storage 1622 and/or storage 1638). Specifically, control circuitry 1608 and/or 1634 may be instructed by the application to perform the functions discussed herein. In some implementations, any action performed by control circuitry 1608 and/or 1634 may be based on instructions received from the application. For example, the application may be implemented as software or a set of executable instructions that may be stored in storage 1622 and/or 1638 and executed by control circuitry 1608 and/or 1634. In some embodiments, the application may be a client/server application where only a client application resides on main ECU 1602, and a server application resides on server 1604.

The application may be implemented using any suitable architecture. For example, it may be a stand-alone application wholly implemented on main ECU 1602. In such an approach, instructions for the application are stored locally (e.g., in storage 1622), and data for use by the application is downloaded on a periodic basis (e.g., from an out-of-band feed, from an Internet resource, or using another suitable approach). Control circuitry 1608 may retrieve instructions for the application from storage 1622 and process the instructions to perform the functionality described herein. Based on the processed instructions, control circuitry 1608 may determine a type of action to perform in response to input received from input/output circuitry 1612 or from communication networks 1606 and 1656.

In client/server-based embodiments, control circuitry 1608 may include communication circuitry suitable for communicating with an application server (e.g., server 1604) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication networks 1606 and 1656). In another example of a client/server-based application, control circuitry 1608 runs a web browser that interprets web pages provided by a remote server (e.g., server 1604). For example, the remote server may store the instructions for the application in a storage device. The remote server may process the stored instructions using circuitry (e.g., control circuitry 1634) and/or generate displays. Main ECU 1602 may receive the displays generated by the remote server and may display the content of the displays locally via display 1610. This way, the processing of the instructions is performed remotely (e.g., by server 1604) while the resulting displays, such as the display windows described elsewhere herein, are provided locally on main ECU 1604. Main ECU 1602 may receive inputs from the user via input/output circuitry 1612 and transmit those inputs to the remote server for processing and generating the corresponding displays. Alternatively, main ECU 1602 may receive inputs from the user via input/output circuitry 1612 and process and display the received inputs locally, by control circuitry 1608 and display 1610, respectively.

Server 1604 and main ECU 1602 may transmit and receive content and data such as media content via communication networks 1606 and 1656. For example, server 1604 may be a media content provider, and main ECU 1604 may be a smart television configured to download or stream media content, such as a live news broadcast, from server 1604. Control circuitry 1634, 1608 may send and receive commands, requests, and other suitable data through communication networks 1606 and 1656 using communication circuitry 1632, 1626, respectively. Alternatively, control circuitry 1634, 1608 may communicate directly with each other using communication circuitry 1632, 1626, respectively, avoiding communication networks 1606 and 1656.

It is understood that main ECU 1602 is not limited to the embodiments and methods shown and described herein. In nonlimiting examples, main ECU 1602 may be a television, a Smart TV, a set-top box, an integrated receiver decoder (IRD) for handling satellite television, a digital storage device, a digital media receiver (DMR), a digital media adapter (DMA), a streaming media device, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or combination of the same capable of suitably displaying and manipulating media content.

Main ECU 1602 receives user input 1614 at input/output circuitry 1612. For example, main ECU 1602 may receive a user input such as a user swipe or user touch. It is understood that main ECU 1602 is not limited to the embodiments and methods shown and described herein.

User input 1614 may be received from a user selection-capturing interface that is separate from device 1602, such as a remote-control device, trackpad or any other suitable user movement-sensitive, audio-sensitive or capture devices, or as part of device 1602, such as a touchscreen of display 1610. Transmission of user input 1614 to main ECU 1602 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, or any other suitable wireless transmission protocol. Input/output circuitry 1512 may include a physical input port such as a 3.5 mm audio jack, RCA audio jack, USB port, ethernet port, or any other suitable connection for receiving audio over a wired connection, or may include a wireless receiver configured to receive data via Bluetooth, Wi-Fi, WiMAX, GSM, UTMS, CDMA, TDMA, 3G, 4G, 4G LTE, 5G, or other wireless transmission protocols.

Processing circuitry 1618 may receive user input 1614 from input/output circuitry 1612 using communication path 1616. Processing circuitry 1618 may convert or translate the received user input 1614 that may be in the form of audio data, visual data, gestures or movement to digital signals. In some embodiments, input/output circuitry 1612 performs the translation to digital signals. In some embodiments, processing circuitry 1618 (or processing circuitry 1636, as the case may be) carries out disclosed processes and methods.

Processing circuitry 1618 may provide requests to storage 1622 by communication path 1620. Storage 1622 may provide requested information to processing circuitry 1618 by communication path 1646. Storage 1622 may transfer a request for information to communication circuitry 1626 which may translate or encode the request for information to a format receivable by communication network 1606 before transferring the request for information by communication path 1628. Communication network 1606 may forward the translated or encoded request for information to communication circuitry 1632, by communication paths 1630.

At communication circuitry 1632, the translated or encoded request for information, received through communication path 1630, is translated or decoded for processing circuitry 1636, which will provide a response to the request for information based on information available through control circuitry 1634 or storage 1638, or a combination thereof. The response to the request for information is then provided back to communication network 1606 by communication path 1640 in an encoded or translated format such that communication network 1606 can forward the encoded or translated response back to communication circuitry 1626 by communication path 1642.

At communication circuitry 1626, the encoded or translated response to the request for information may be provided directly back to processing circuitry 1618 by communication path 1654, or may be provided to storage 1622 through communication path 1644, which then provides the information to processing circuitry 1618 by communication path 1646. Processing circuitry 1618 may also provide a request for information directly to communication circuitry 1626 though communication path 1652, where storage 1626 responds to an information request, provided through communication path 1620 or 1644, by communication path 1624 or 1646 that storage 1622 does not contain information pertaining to the request from processing circuitry 1618.

Processing circuitry 1618 may process the response to the request received through communication paths 1646 or 1654 and may provide instructions to display 1610 for a notification to be provided to the users through communication path 1648. Display 1610 may incorporate a timer for providing the notification or may rely on inputs through input/output circuitry 1612 from the user, which are forwarded through processing circuitry 1618 through communication path 1648, to determine how long or in what format to provide the notification. When display 1610 determines the display has been completed, a notification may be provided to processing circuitry 1618 through communication path 1650.

Vehicle system 1500 of FIG. 15 is communicatively coupled to communication networks 1606 and 1656 in order to transmit and receive instructions, statuses, and data to each of server 1604 and main ECU 1602. For example, vehicle system 1500 may receive an instruction to activate a watchdog mode from main ECU 1602 based on user input 1614. The instruction may be transmitted via communication stream 1628 to communication network 1606, which then transmits the instruction with a status update to both communication circuitry 1632, corresponding to server 1604 (e.g., a relocation service server), via communication stream 1630 and to vehicle system 1500 via communication stream 1658. Additionally, server 1604 may also transmit a redundant security encoded iteration of the instruction to confirm the instruction with vehicle system 1500 by transmitting a message via communication stream 1660 through communication network 1656 which is received at vehicle system 1500 via communication stream 1662. Vehicle system 1500 executes a change to activate watchdog mode and executes autonomous instructions (e.g., as depicted in FIGS. 1 and 2). Once the instructions are completed, vehicle system 1500 may provide new data and a new status update to main ECU 1602 via communication stream 1664 through communication network 1606 and/or may transmit the same data and/or status update to server 1604 via communication network 1656 using communication streams 1666 and 1668. Additionally, updates may be provided during execution of autonomous instructions in order to request updates (e.g., via a vehicle relocation service which generates escape trajectories to safe locations) to the autonomous instructions (e.g., there is a change in the environment around vehicle system 1500 during execution of autonomous instructions and a new evasive route is needed based on real-time data collected and transmitted from vehicle system 1500).

The communication paths provided in FIG. 16 between main ECU 1602, server 1604, communication network 1606, and all subcomponents depicted are exemplary and may be modified to reduce processing time or enhance processing capabilities for each step in the processes disclosed herein by one skilled in the art.

FIG. 17 is a flowchart of a detailed illustrative process for transmitting a signed FPGA image to an additional ECU for installation, in accordance with some embodiments of this disclosure. In various embodiments, the individual steps of process 1700 may be implemented by one or more components of the devices and systems of FIGS. 1-16. Although the present disclosure may describe certain steps of process 1700 (and of other processes described herein) as being implemented by certain components of the devices and systems of FIGS. 1-16, this is for purposes of illustration only, and it should be understood that other components of the devices and systems of FIGS. 1-16 may implement those steps instead.

At 1702, the main ECU, via the control circuitry (e.g., control circuitry 1608 of FIG. 16 which may be implemented by FPGA), receives, at the main ECU of a vehicle, a private key from a certificate authority (similar to FIG. 1A shown at 104). As stated earlier, control circuitry 1608 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, the main ECU may receive the private key via the communication network 1609, via the I/O path 1612 from user equipment 1607, 1608, 1610.

At 1704, the main ECU, via the control circuitry 1608, stores the private key in a hardware security module (HSM) of the main ECU. The private key may be stored in at least one of storage 1614, database 1605, or user equipment 1607, 1608, and 1610 functioning as an HSM.

At 1706, the main ECU, via the control circuitry 1608, generates a symmetric vehicle-specific key based on at least one vehicle parameter of the vehicle (similar to FIG. 1A shown at 106). At 1708, the main ECU, via the control circuitry 1608, stores the symmetric vehicle-specific key in the HSM of the main ECU. The symmetric vehicle-specific key may be stored in at least one of storage 1614, database 1605, or user equipment 1607, 1608, and 1610 functioning as an HSM.

At 1710, the main ECU, via the control circuitry 1608, detects a presence of an additional ECU on a vehicle communication network of the vehicle (similar to FIG. 1B shown at 112). The additional ECU comprises a field programmable gate array (FPGA) that includes an unprovisioned vehicle control operation. The detection may take place via the communication network 1609, via the I/O path 1612 from user equipment 1607, 1608, 1610. If, at 1712, the main ECU, via control circuitry 1608, does not detect the presence of the additional ECU on the vehicle communication network of the vehicle, the process reverts to 1710. If, at 1712, the main ECU, via control circuitry 1608, detects the presence of the additional ECU on the vehicle communication network of the vehicle, the process continues to 1714. At 1714, the main ECU, via the control circuitry 1608, generates and encrypts an FPGA image for the additional ECU. The encrypted FPGA image includes the symmetric vehicle-specific key.

At 1716, the main ECU, via the control circuitry 1608, cryptographically signs the FGPA image using the private key stored in the HSM of the main ECU (similar to FIG. 1B shown at 114). At 1718, the main ECU, via the control circuitry 1608, transmits, via the vehicle communication network (e.g., 1609), the signed FPGA image to the additional ECU for installation (similar to FIG. 1B shown at 116). The additional ECU is configured to verify the signed FPGA image using a public key provided by the certificate authority. The installation causes the additional ECU configured with the FPGA image to perform the vehicle control operations and communicate via the vehicle communication network (e.g., 1609) using the symmetric vehicle-specific key.

FIG. 18 is a flowchart of a detailed illustrative process 1800 for generating a new FPGA image for the additional ECU in response to the expiration date determined to be within an expiration threshold, in accordance with some embodiments of this disclosure. At 1802, the main ECU, via the control circuitry 1608 which may be implemented by FPGA, determines an expiration date of the signed FPGA image. If, at 1804, the main ECU, via control circuitry 1608, determines that the current date is not within a threshold of the expiration date, the process reverts to 1802. If, at 1804, the main ECU, via control circuitry 1608, determines that the current date is within the threshold of the expiration date, the process continues to 1806. At 1806, the main ECU, via the control circuitry 1608, generates an FPGA image for the additional ECU. The encrypted FPGA image includes a new symmetric vehicle-specific key.

At 1808, the main ECU, via the control circuitry 1608, cryptographically signs the FGPA image using the symmetric vehicle-specific key. At 1810, the main ECU, via the control circuitry 1608, transmits, via the vehicle communication network (e.g., 1609), the signed FPGA image to the additional ECU for installation. The additional ECU is configured to decrypt the encrypted new FPGA image using the symmetric vehicle-specific key previously stored as part of installation of the FPGA image. The installation of the new FPGA image causes the additional ECU to perform the vehicle control operations using the new symmetric vehicle-specific key.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a main electronic control unit (ECU) of a vehicle, a private key from a certificate authority;
storing the private key in a hardware security module (HSM) of the main ECU;
generating, by the main ECU, a symmetric vehicle-specific key based on at least one vehicle parameter of the vehicle;
storing the symmetric vehicle-specific key in the HSM of the main ECU;
detecting a presence of an additional ECU on a vehicle communication network of the vehicle, wherein the additional ECU comprises a field programmable gate array (FPGA) that includes an unprovisioned vehicle control operation;
generating an FPGA image for the additional ECU, wherein the FPGA image comprises the symmetric vehicle-specific key;
cryptographically signing the FPGA image using the private key stored in the HSM of the main ECU; and
transmitting, via the vehicle communication network, the signed FPGA image to the additional ECU for installation, wherein the additional ECU is configured to verify the signed FPGA image using a public key provided by the certificate authority, and wherein the installation causes the additional ECU provisioned with the FPGA image to perform the vehicle control operations and communicate via the vehicle communication network using the symmetric vehicle-specific key.

2. The method of claim 1, wherein the additional ECU is preprovisioned with a provisional FPGA image that enables the additional ECU to perform networking and cryptographic operations and does not enable the additional ECU to perform the vehicle control operations;
wherein the additional ECU is provisioned to:
receive the public key from the certificate authority using the provisional FPGA image; and
verify the signed FPGA image based at least in part on decrypting a signature of the FPGA image that was signed using the private key.

3. The method of claim 1, further comprising:
transmitting, by the main ECU to the additional ECU, a provisional FPGA image that when installed by the additional ECU enables the additional ECU to perform networking and cryptographic operations and does not enable the additional ECU to perform the vehicle control operations;
wherein the additional ECU is provisioned to:
receive the public key from the certificate authority using the provisional FPGA image; and
verify the signed FPGA image based at least in part on decrypting a signature of the FPGA image that was signed using the private key.

4. The method of claim 1, wherein the vehicle parameter of the vehicle includes at least one of: vehicle identification number (VIN) of the vehicle, odometer reading of the vehicle, serial number of the vehicle, engine model number of the vehicle, or a part number of the vehicle.

5. The method of claim 1, wherein the certificate authority comprises at least one server operated by a manufacturer of the vehicle.

6. The method of claim 1, wherein the generating, by the main ECU, the symmetric vehicle-specific key, comprises:
applying a hash function to the at least one vehicle parameter of the vehicle to generate a hashed vehicle parameter; and
generating the symmetric vehicle-specific key based on at least the hashed vehicle parameter.

7. The method of claim 1, wherein the vehicle communication network comprises an ethernet bus, and
wherein the additional ECU is provisioned to communicate via the vehicle communication network by encrypting ethernet frames that the additional ECU transmits via the ethernet bus using the symmetric vehicle-specific key.

8. The method of claim 1, further comprising:
determining an expiration date of the signed FPGA image;
in response to determining that a current date is within a threshold of the expiration date:
generating a new FPGA image for the additional ECU, wherein the new FPGA image comprises a new symmetric vehicle-specific key;
cryptographically encrypting the new FPGA image using the symmetric vehicle-specific key; and
transmitting, via the vehicle communication network, the encrypted new FGPA image to the additional ECU for installation, wherein the additional ECU is provisioned to decrypt the encrypted new FPGA image using the symmetric vehicle-specific key previously stored as part of installation of the FPGA image, and wherein installation of the new FPGA image causes the additional ECU to perform the vehicle control operations using the new symmetric vehicle-specific key.

9. The method of claim 8, further comprising revoking the symmetric vehicle-specific key for the additional ECU at the expiration date.

10. The method of claim 1, further comprising:
configuring for the vehicle communication network a plurality of virtual local area networks (VLANs);
configuring a first subset of ECUs of the vehicle to communicate via a first VLAN of the plurality of VLANs, wherein the first subset of ECUs are provisioned to encrypt communications using the symmetric vehicle-specific key;
configuring a second subset of ECUs of the vehicle to communicate via a second VLAN of the plurality of VLANs, wherein the second subset of ECUs are provisioned to encrypt communications using an additional symmetric vehicle-specific key based on at least one additional vehicle parameter of the vehicle different from the at least one vehicle parameter of the vehicle used to generate the symmetric vehicle-specific key.

11. A system comprising:
control circuitry configured to:
receive, at a main electronic control unit (ECU) of a vehicle, a private key from a certificate authority;
store the private key in a hardware security module (HSM) of the main ECU;
generate, by the main ECU, a symmetric vehicle-specific key based on at least one vehicle parameter of the vehicle;
store the symmetric vehicle-specific key in the HSM of the main ECU;
detect a presence of an additional ECU on a vehicle communication network of the vehicle, wherein the additional ECU comprises a field programmable gate array (FPGA) that includes an un-provisioned vehicle control operation;
generate an FPGA image for the additional ECU, wherein the FPGA image comprises the symmetric vehicle-specific key;
cryptographically sign the FPGA image using the private key stored in the HSM of the main ECU; and
transmit, via the vehicle communication network, the signed FPGA image to the additional ECU for installation, wherein the additional ECU is configured to verify the signed FPGA image using a public key provided by the certificate authority, and wherein the installation causes the additional ECU provisioned with the FPGA image to perform the vehicle control operations and communicate via the vehicle communication network using the symmetric vehicle-specific key.

12. The system of claim 11, wherein the additional ECU is pre-provisioned with a provisional FPGA image that enables the additional ECU to perform networking and cryptographic operations and does not enable the additional ECU to perform the vehicle control operations;
wherein the additional ECU is provisioned to:
receive the public key from the certificate authority using the provisional FPGA image; and
verify the signed FPGA image based at least in part on decrypting a signature of the FPGA image that was signed using the private key.

13. The system of claim 11, wherein the control circuitry is further configured to:
transmit, by the main ECU to the additional ECU, a provisional FPGA image that when installed by the additional ECU enables the additional ECU to perform networking and cryptographic operations and does not enable the additional ECU to perform the vehicle control operations;
wherein the additional ECU is provisioned to:
receive the public key from the certificate authority using the provisional FPGA image; and
verify the signed FPGA image based at least in part on decrypting a signature of the FPGA image that was signed using the private key.

14. The system of claim 11, wherein the vehicle parameter of the vehicle includes at least one of: vehicle identification number (VIN) of the vehicle, odometer reading of the vehicle, serial number of the vehicle, engine model number of the vehicle, or a part number of the vehicle.

15. The system of claim 11, wherein the certificate authority comprises at least one server operated by a manufacturer of the vehicle.

16. The system of claim 11, wherein the control circuitry is configured when generating, by the main ECU, the symmetric vehicle-specific key, to:
apply a hash function to the at least one vehicle parameter of the vehicle to generate a hashed vehicle parameter; and
generate the symmetric vehicle-specific key based on at least the hashed vehicle parameter.

17. The system of claim 11, wherein the vehicle communication network comprises an ethernet bus, and
wherein the additional ECU is provisioned to communicate via the vehicle communication network by encrypting ethernet frames that the additional ECU transmits via the ethernet bus using the symmetric vehicle-specific key.

18. The system of claim 11, wherein the control circuitry is further configured to:
determine an expiration date of the signed FPGA image;
in response to determining that a current date is within a threshold of the expiration date:
generate a new FPGA image for the additional ECU, wherein the new FPGA image comprises a new symmetric vehicle-specific key;
cryptographically encrypt the new FPGA image using the symmetric vehicle-specific key; and
transmit, via the vehicle communication network, the encrypted new FGPA image to the additional ECU for installation, wherein the additional ECU is provisioned to decrypt the encrypted new FPGA image using the symmetric vehicle-specific key previously stored as part of installation of the FPGA image, and wherein installation of the new FPGA image causes the additional ECU to perform the vehicle control operations using the new symmetric vehicle-specific key.

19. The system of claim 18, wherein the control circuitry is further configured to revoke the symmetric vehicle-specific key for the additional ECU at the expiration date.

20. The system of claim 11, wherein the control circuitry is further configured to:
configure for the vehicle communication network a plurality of virtual local area networks (VLANs);
configure a first subset of ECUs of the vehicle to communicate via a first VLAN of the plurality of VLANs, wherein the first subset of ECUs are provisioned to encrypt communications using the symmetric vehicle-specific key;
configure a second subset of ECUs of the vehicle to communicate via a second VLAN of the plurality of VLANs, wherein the second subset of ECUs are provisioned to encrypt communications using an additional symmetric vehicle-specific key based on at least one additional vehicle parameter of the vehicle different from the at least one vehicle parameter of the vehicle used to generate the symmetric vehicle-specific key.

21-50. (canceled)
